(19) United States
(12) Patent Application Publication
(10) Pub. No.: US 2026/0041602 A1
(43) Pub. Date: Feb. 12, 2026

(54) Wearable Body with Removable Massage System

(71) Applicant: Li Zhijian, Fuzhou (CN)

(72) Inventor: Li Zhijian, Fuzhou (CN)

(21) Appl. No.: 19/366,422

(22) Filed: Oct. 22, 2025

Related U.S. Application Data
(63) Continuation-in-part of application No. 19/303,078, filed on Aug. 18, 2025.
Application No. 19/303,078 is a continuation-in-part of application No. 18/214,550, filed on Jun. 27, 2023.
Application No. 18/214,550 is a continuation-in-part of application No. 17/575,930, filed on Jan. 14, 2022, now Pat. No. 11,723,831.
Application No. 17/575,930 is a continuation of application No. 17/486,988, filed on Sep. 28, 2021, now Pat. No. 12,350,223.
Application No. 17/486,988 is a continuation of application No. 16/693,259, filed on Nov. 23, 2019, now Pat. No. 11,426,324.
Application No. 17/486,988 is a continuation of application No. 16/850,043, filed on Apr. 16, 2020, now Pat. No. 11,344,469.
Application No. 17/486,988 is a continuation of application No. 16/885,324, filed on May 28, 2020, now Pat. No. 11,337,887.
Application No. 16/885,324 is a continuation-in-part of application No. 16/850,043, filed on Apr. 16, 2020, now Pat. No. 11,344,469.
Application No. 16/850,043 is a continuation-in-part of application No. 16/693,259, filed on Nov. 23, 2019, now Pat. No. 11,426,324.
Application No. 16/693,259 is a continuation-in-part of application No. 16/693,452, filed on Nov. 25, 2019, now Pat. No. 10,888,494.
Application No. 16/693,452 is a continuation-in-part of application No. 16/693,259, filed on Nov. 23, 2019, now Pat. No. 11,426,324.
Application No. 17/486,988 is a continuation of application No. 17/149,806, filed on Jan. 15, 2021.
Application No. 17/149,806 is a continuation-in-part of application No. 16/885,324, filed on May 28, 2020, now Pat. No. 11,337,887.
Application No. 18/214,550 is a continuation-in-part of application No. 17/149,806, filed on Jan. 15, 2021.
Application No. 17/149,806 is a continuation-in-part of application No. 16/850,043, filed on Apr. 16, 2020, now Pat. No. 11,344,469.
Application No. 16/850,043 is a continuation-in-part of application No. 16/693,452, filed on Nov. 25, 2019, now Pat. No. 10,888,494.
(60) Provisional application No. 62/834,551, filed on Apr. 16, 2019.
(60) Provisional application No. 62/834,551, filed on Apr. 16, 2019.
(60) Provisional application No. 62/854,261, filed on May 29, 2019.
(60) Provisional application No. 63/684,765, filed on Aug. 19, 2024.
(60) Provisional application No. 63/710,550, filed on Oct. 22, 2024.

(51) Int. Cl. A61H 23/02; A45F 3/00; A45F 3/04

(52) U.S. Cl. CPC A61H 23/02; A45F 3/04; A45F 2003/003; A45F 2003/045; A61H 2201/1207; A61H 2201/1626; A61H 2201/165; A61H 2201/5007; A61H 2201/5043; A61H 2205/081

(57) ABSTRACT

A biomechanically adaptive wearable system includes a wearable body configured to be worn on a user's torso and to bear a load. A removable massage system is detachably integrated with the wearable body. The removable massage system includes at least at least one massage head structurally integrated with the wearable body via at least one pair of a detachable accessory. The at least one massage head includes a massage actuator; and a pressure sensor configured to detect, in real-time, pressure variations originating from the load and the user's torso. A control system includes a microcontroller unit programmed to receive and analyze the signals from the pressure sensor to determine a required adjustment to massage intensity; and automatically generate and send a control command to the massage actuator to operate according to the determined required adjustment.

### FIELD

The present invention relates to the field of backpacks, in particular, an adjustable massage structure and massage backpack for a close fit that can include an optional removable massage system. After a series of innovative, fully considering the scientific, ergonomic and other factors, composite innovated the detailed sizes and structures, invented a more close-fitting, adjustable special and comfortable effect of the massage backpack that can include an optional removable massage system.

### BACKGROUND

Existing backpacks provide convenience for people to carry items on their trips, but still have the following defects: due to the weight of the items in the backpack, the backpacker's shoulders, back and waist are under pressure, and over time, the backpacker will feel uncomfortable and prone to fatigue and pain, which damages the user's health. With the advancement of technology, backpacks with massage function have been designed on the traditional backpack. The existing massage backpack is generally installed on the shoulder straps, and the massage position of the massage head is mostly by adjusting the elasticity of the shoulder straps to carry out, in the process of adjusting the elasticity of the shoulder straps in the backpack the up and down position on the human back also changed at the same time, the use experience is compromised, and only using the shoulder strap structure, the massage head and the human shoulder is not fit enough, massage effect is poor.

### SUMMARY

The purpose of the present invention is: to overcome the above shortcomings to provide an adjustable massage structure and massage backpack, the massage structure and massage backpack will be separated into the upper and lower back panel, and the upper part of a second set of webbing can be adjusted to the massage position of the massage head, and the second webbing on the shoulder straps to play a pulling role, so that the massage head can fit more closely with the human shoulder and back, massage effect is good.

The present invention is realized through the following technical solutions. Solution I. An adjustable and fit massage structure comprising a back panel and a shoulder strap set on the back panel, wherein the back panel further comprising a connected upper part and a lower part, the upper end of the shoulder strap being connected to the back panel at a position set on the connection line between the upper part and the lower part of the back panel, wherein the lower end of the shoulder strap being connected to the lower part of the back panel through a first webbing, the height h of the back panel being: h≥390 mm, the height d of the upper part being: 110 mm≤d≤147 mm.

Wherein the shoulder strap is provided with a massage head for back and shoulder massage inside, the shoulder strap is connected to the upper part of the back panel with a second webbing for adjusting the shoulder strap and the position of back and shoulder massage, wherein the second webbing is provided with a second adjustment part for adjusting the length of the second webbing.

Preferably, the number of shoulder straps is two and spaced along the width direction of the back panel. Preferably, the second adjusting part is a ladder buckle. In order to allow the second webbing to be adjusted to maintain accurate positioning of the back strap moving up and down, and not to induce left and right shaking, and when tightening, it will not result in a reduced degree of intimacy, the two ends of the second webbing and the second adjustment part are close and located on the substantially same vertical surface.

In order to facilitate the installation of the massage head, the shoulder strap is provided with a storage space for the installation of the massage head, wherein the storage space is provided with a first opening on one side to facilitate the massage head and cable through it, the storage space is elastic and fastened to the outer circumference of the massage head.

In order to facilitate the disassemble of the massage head, the side wall of the shoulder strap is provided with a second opening for opening and closing the internal space of the shoulder strap, wherein the second opening is closed and connected by fasteners. Preferably, the shoulder strap is also provided with a fastening device to hold the second webbing to reduce noise, the fastening device can be an elastic band or hook and loop (Velcro®).

Solution II. A massage backpack comprising the fit adjustable massage structure described in Solution I and a bag body connected thereto, the bag body being fixed or detachably connected to the back panel. Compared with the prior technology, the beneficial effects of the present invention are. 1. the invention provides a close-fitting, adjustable massage structure and massage backpack, the massage structure and massage backpack comprises an upper and a lower part on the back panel, with a special size setting, and a second webbing set in the upper part can be adjusted to the massage position of the massage head, and the second webbing on the shoulder straps to play a pulling role, so that the massage head can fit more closely with the human shoulder and back position, through these multi-point organic coordination combinations makes, massaging effect getting better. And the invention and innovation of this product size, that is, the scientific combination of the back panel height and the upper part height size, is an important factor to achieve the effect of invented massaging backpack. 2. The present invention provides a fit and adjustable massage structure and massage backpack, wherein the two ends of the second webbing and the second adjustment component are close and located on the substantially same vertical surface. This way the second webbing can keep the positioning of the backpack moving up and down accurately when adjusting, without creating left and right shaking. It will not cause a gap between the back of the main body and the shoulder or back of the human body, when tightening the webbing which forms a deviation. 3. The present invention provides a snug and adjustable massage structure and massage backpack, wherein an opening is set at the side of the shoulder strap and an elastic storage pocket is set inside the shoulder strap to facilitate the disassemble and assemble of the massage head. 4. The invention provides an adjustable massage structure and massage backpack, the massage structure and other parts of the backpack are independent structures, later the entire back system can be sewn directly to other parts to complete the backpack sewing, which can improve production efficiency.

In some embodiments, a biomechanically adaptive wearable system includes a wearable body configured to be worn on a user's torso and to bear a load, thereby applying pressure to the user's torso. A removable massage system is detachably integrated with the wearable body. The removable massage system includes at least one storage space configured to house components of the massage system. The components of the removable massage system comprise a control system, at least one massage head, and a function control panel, interconnected by at least two cables. The removable massage system is provided with at least one pair of a detachable accessory, enabling the entire removable massage system to be detached from the wearable body as a single, complete unit. The at least one massage head is structurally integrated with the wearable body via the detachable accessories to form a force-coupling interface, enabling transmission of mechanical forces between the wearable body, the user's torso, and the massage head. The control system comprises a microcontroller unit (MCU) and a crystal oscillator, the crystal oscillator being configured to provide a stable clock signal to the MCU. The massage head comprises a massage actuator and a pressure sensor configured to detect, in real-time, pressure variations originating from the load and the user's torso, and to transmit corresponding signals to the MCU. The MCU is programmed to: receive and analyze the signals from the pressure sensor to determine a required adjustment to massage intensity; and automatically generate and send a control command to the massage actuator to adjust its operation, thereby providing a massage mode tailored to the detected pressure distribution.

In some embodiments, a biomechanically adaptive wearable system includes a wearable body configured to be worn on a user's torso and to bear a load, thereby applying pressure to the user's torso. A removable massage system is detachably integrated with the wearable body. The removable massage system includes at least one storage space configured to house components of the massage system. The components of the removable massage system comprise a control system, at least one massage head, and a function control panel, interconnected by at least two cables. The removable massage system is provided with at least one pair of detachable accessories, enabling the entire removable massage system to be installed on and detached from the wearable body as a single, complete unit, thereby allowing it to be affixed only when massage functionality is required to enhance physical contact and improve conformity between the massage system and the user's torso. The wearable body is provided with at least one pair of adjustable fastening accessories, configured to be tightened or loosened to adjust a fitting tightness of the wearable body against the user's torso. The at least one massage head is structurally integrated with the wearable body via the detachable accessories to form a force-coupling interface, enabling transmission of mechanical forces between the wearable body, the user's torso, and the massage head. A combined effect of the adjustable fastening accessories securing the wearable body to the user and the detachable accessories integrating the massage head with the wearable body concurrently enhances physical contact of the massage head against the user's torso, thereby improving massage efficacy and comfort when the massage function is activated.

In some embodiments, a biomechanically adaptive wearable system includes a wearable body configured to be worn on a user's torso and to bear a load. A removable massage system is detachably integrated with the wearable body. The removable massage system includes at least at least one massage head structurally integrated with the wearable body via at least one pair of a detachable accessory. The at least one massage head includes a massage actuator; and a pressure sensor configured to detect, in real-time, pressure variations originating from the load and the user's torso. A control system includes a microcontroller unit programmed to receive and analyze the signals from the pressure sensor to determine a required adjustment to massage intensity; and automatically generate and send a control command to the massage actuator to operate according to the determined required adjustment.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a schematic diagram I of the structure of implementation I of the present invention.

FIG. 2 is a schematic diagram of the structure of implementation I of the present invention II.

FIG. 3 is a schematic diagram of the structure of implementation I of the present invention III.

FIG. 4 is a schematic diagram I of the use state of implementation I of the present invention.

FIG. 5 is a schematic diagram of the use state of implementation I of the present invention II.

FIG. 6 depicts an embodiment of the present invention.

FIG. 7 depicts an embodiment of the present invention.

FIG. 8 depicts an embodiment of the present invention.

FIG. 9 depicts an embodiment of the present invention

FIG. 10 depicts an embodiment of the present invention.

FIG. 11 depicts an embodiment of the present invention.

FIG. 12 depicts an embodiment of the present invention.

FIG. 13 depicts an embodiment of the present invention.

FIG. 14 depicts an embodiment of the present invention.

FIG. 15 depicts an embodiment of the present invention.

FIG. 16 depicts an embodiment of the present invention.

FIG. 17 depicts an embodiment of the present invention.

FIG. 18 depicts an embodiment of the present invention.

FIG. 19 depicts an embodiment of the present invention.

FIG. 20 depicts an embodiment of the present invention.

FIG. 21 depicts an embodiment of the present invention.

FIG. 22 depicts an embodiment of the present invention.

FIGS. 23A, 23B, 23C, and 23D illustrate an embodiment of a backpack including a massage apparatus in accordance with another aspect of the present development.

FIGS. 24A, 24B, 24C, 24D, and 24E illustrate an embodiment of a backpack including a massage apparatus in accordance with a further aspect of the present development.

FIGS. 25A, 25B, 25C, 25D, 25E, and 25F illustrate an embodiment of a backpack including a massage apparatus in accordance with another aspect of the present development.

FIGS. 26A, 26B, 26C, and 26D illustrate an embodiment of a backpack including a massage apparatus in accordance with a further aspect of the present development.

FIG. 27A illustrates an embodiment of a wearable backpack (wearable body) including a removable massage system in accordance with one aspect of the present development.

FIG. 27B shows the backpack of FIG. 27A with the shoulder straps extended and with portions removed to better illustrate the removable massage system.

FIG. 27C provides another view of the backpack of FIGS. 27A and 27B.

FIG. 28A illustrates an embodiment of a wearable vest (wearable body) including a removable massage system in accordance with another aspect of the present development.

FIG. 28B is similar to FIG. 28A but omits various accessory items (tools, communication equipment, etc.) from the wearable vest and shows the removable massage system partially separates from the vest.

FIG. 29 shows the vest of FIGS. 28A and 28B in a flat inoperative state including the removable massage system connected thereto.

FIGS. 30A and 30B show the vest of FIG. 29 separated into its main components including a vest body (right side of the drawing) and a removable massage system (left side of drawing) that is selectively connected to the vest body to form a vest including a removable massage system and that can be selectively disconnected from the vest body.

FIG. 31A shows a massage head (oscillator) of the removable massage system in accordance with one aspect of the present development.

FIGS. 31B and 31C are respective first and second exploded views of the massage head of FIG. 31A.

FIGS. 32A-42 show other embodiments of the backpack B shown in FIGS. 1-31C.

### DETAILED DESCRIPTION

The present invention is described in detail below in conjunction with the accompanying illustrations.

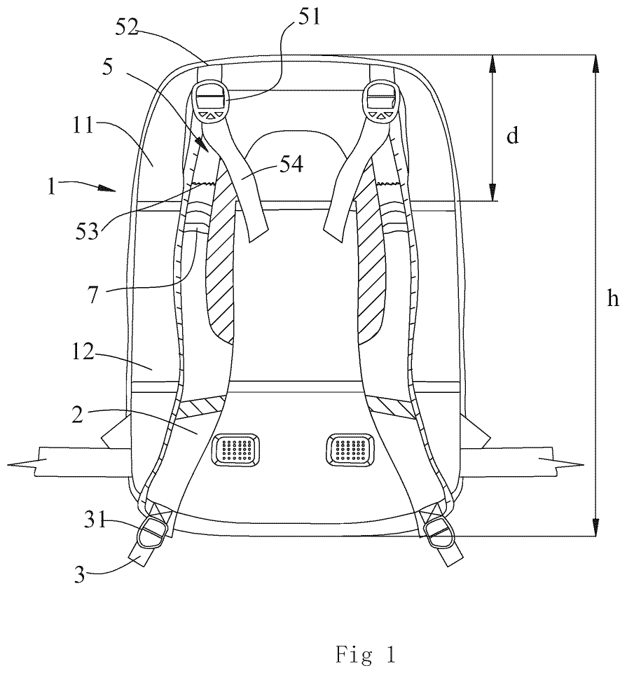

As shown in FIGS. 1-5, a close-fitting and adjustable massage structure, mainly comprising a back panel 1 and a shoulder strap 2 set on the back panel 1, mentioned back panel 1 comprises a connected upper part 11 and a lower part 12, the upper end of the shoulder strap 2 is connected to the back panel 1 at a position set on the connection line of the upper part 11 and the lower part 12 of the back panel 1, wherein the lower end of the shoulder strap 2 is connected to the lower part 12 of the back panel 1 through a first webbing 3, mentioned first adjustment component 31 for adjusting the length of the first webbing 3 is also provided between the first webbing 3 and the shoulder strap 2, the height h of the back panel 1 being: h≥390 mm, the height d of the upper part 11 being: 110 mm≤d≤147 mm. For the value of h, h explains and limits a reasonable size of the back panel of a backpack used by people from high school students to other ages of adults. The general adaptability of this size backpack is for 1) go to school, 2) commute; 3) travel. This kind of backpack users need to bear weight for a long time. The present invention aims at this specific demand, and fully considers the adult's height, back height, back thickness and other factors to create the value of h to achieve massage backpack products in reasonable range of back sizes. In order to improve the relatively complex structure, high cost and heavier weight of the product described in previous inventions, the present invention provides an innovative and new approach, namely: to have the shoulder strap stitch directly to the back panel of the backpack. If the size of this approach is not reasonable enough, it will cause a gap between the massage head on the strap and the area that needs to be massaged (from the upper back to the shoulders). After much research and testing it was discovered that having a huge number of people in different heights, body types, and back thicknesses, a solution is to find a common divisor and methods to create the best and suitable structures for a multitude of sizes for people of different body types, which can also form a tight-fitting effect, so as to achieve the best goal of good massage effect. As a result, we innovated the structure and size range of d. Only in this interval, our massage products can best match the body thickness of most adult people to achieve a better comfortable massage effect. The design of the second adjustment part (51), upper stitching (52), lower stitching (53), and protruding section (54), combined with the best size of d, achieves that the back panel of the massage backpack can be used by a multitude of people, which is comfortable and effective. A key point of the invention is: d is the best numerical range that we have verified through countless experiments and verifications during the past 2 years. This is not a numerical range that can be calculated by the existing formulas, this is an important invention which be created by now. At the same time, this innovative product will have a more scientific and effective massage effect. Therefore, this is part of the extended innovation and continuous innovation of the applicant's massage creations. It is the result of creative invention that has been obtained through rounds of experiments, revisions, retests, and revisions.

Wherein the shoulder strap 2 is provided with a massage head 4 for back and shoulder massage inside, mentioned shoulder strap 2 is connected to the upper part 11 of the back panel 1 with a second webbing 5 for adjusting the position of the shoulder strap 2 and back and shoulder massage, the second webbing 5 is provided with a second adjusting part 51 for adjusting the length of the second webbing 5. The height h of the mentioned back panel 1 and the height d of the upper part 11 are the dimensions of the product after stitching. It is noted the invention may be just at least one shoulder strap without departing from the present invention. Preferably, the number of mentioned shoulder straps 2 is two and spaced along the width direction of the back panel 1.

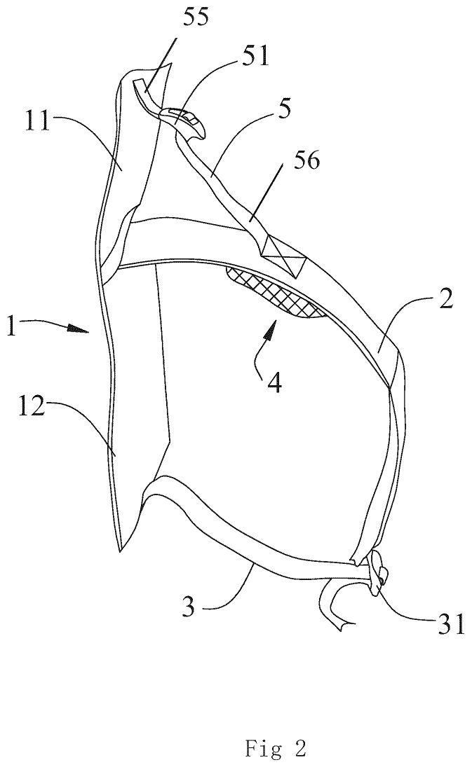

As shown in FIGS. 1-2, in order to facilitate the adjustment of the length of the webbing, the first adjustment part 31 and the second adjustment part 51 are both ladder buckles. This implementation uses the ladder buckle for the adjustment of the webbing, but it is not limited to the ladder buckle, but can also be other adjustment devices, such as belt-type pin and hole connection structure, or pawl and tooth slot mating structure.

As shown in FIG. 2, in order to make the best massage effect and the best fit with the human body, and the second webbing can be adjusted to keep the positioning of the back belt moving up and down accurately, and will not induce left and right shaking, the two ends of the second webbing 5 and the second adjustment component 51 are close and located on the substantially same vertical surface. As shown in FIG. 1, the upper end seam 52, the lower end seam 53 and the second adjustment part 51 of the second webbing 5 are close and located on the substantially same vertical surface.

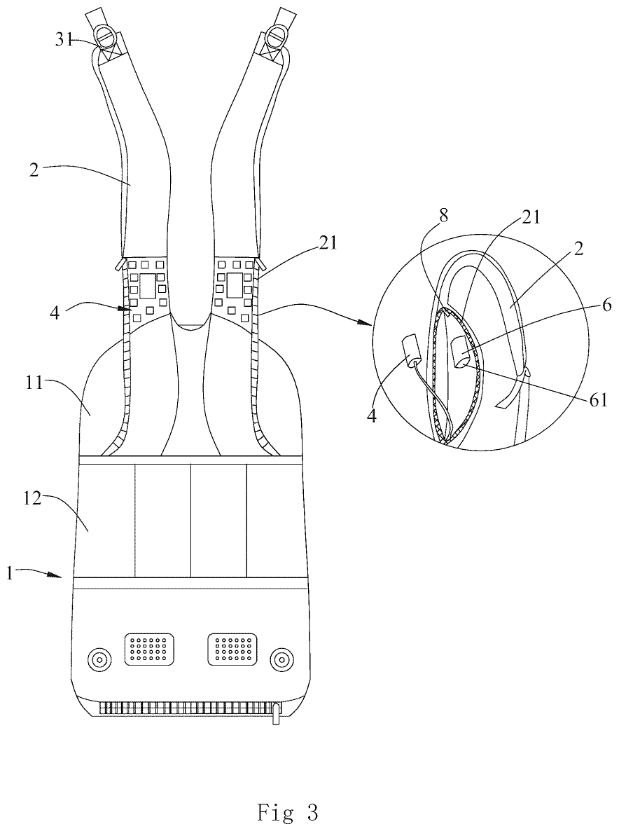

As shown in FIG. 3, in order to facilitate the installation of the massage head, the interior of the shoulder strap 2 is provided with a storage space 6 for the installation of the massage head 4, the storage space 6 is provided with a first opening 61 on one side to facilitate the massage head 4 and cable penetration into it, the storage space 6 is elastic and fastened to the outer circumference of the massage head.

As shown in FIG. 3, in order to facilitate the disassemble of the massage head, the side wall of the shoulder strap 2 is provided with a second opening 21 for opening and closing the internal space of the shoulder strap 2, mentioned second opening 21 through the fastener 8 to close the connection. This implementation of the fastener 8 is a zipper assemble, but also can be a dual lock, hook and loop (Velcro®) or other matching connection structure.

In order to fix the end of the second webbing to reduce noise, the shoulder strap 2 is also provided with a fastening part 7 that holds the second webbing 5 in place to reduce noise, and the fastening device 7 may be an elastic band or hook and loop (Velcro®). As shown in FIG. 1, the second webbing 5 outstretched section 54 can be fixed by the fastening device 7 to prevent the massage head in the vibration process to drive the outstretched section 54 resonance to reduce noise.

With reference to the FIGS. 1-5, an adjustable massage structure is provided, having a back panel (1) and at least one shoulder strap (2) set on the back panel (1), wherein the back panel (1) further comprises a connected upper part (11) and a lower part (12), wherein the upper end of the at least one shoulder strap (2) is connected to the back panel (1) at a position set on the connection line of the upper part (11) and the lower part (12) of the back panel (1), wherein the lower end of the at least one shoulder strap (2) is connected to the lower part (12) of the back panel (1) by means of a first webbing (3), wherein the at least one shoulder strap (2) is provided with a massage head (4) inside, wherein the at least one shoulder strap (2) and the upper part (11) of the back panel (1) is connected with a second webbing (5) for adjustment of the shoulder strap (2), wherein the second webbing (5) is provided with a second adjustment part (51) for adjusting the length of the second webbing (5). There may be two shoulder straps (2) spaced along the width of the backboard (1). The second adjustment part (51) may be a ladder buckle (as shown in FIG. 1). The ends of the second webbing (5) and the second adjustment part (51) are located on a substantially vertical surface, wherein the second webbing (5) is divided into two sections, an upper section (55) and a lower section (56), wherein the upper section (55) and the lower section (56) are integrated through the second adjustment part (51). The interior of the shoulder strap (2) is provided with a storage space (6) for the installation of the massage head (4). A side wall of the shoulder strap (2) is provided with a second opening (21) for opening and closing the internal space of the shoulder strap (2), wherein the second opening (21) is connected by fasteners (8) for closure. The shoulder straps (2) may also be provided with a fastening part (7) to hold the second webbing (5) to reduce noise, the fastening part (7) is an elastic band or hook and loop (Velcro®).

The massage structure is close-fitting to a user's body and adjustable in structure, with a bag body connected thereto, wherein the bag body being fixed or detachably connected to the back panel. The height h of the back panel (1) being greater than or equal to 390 mm, and the height d of the upper part (11) being greater than or equal to 110 mm and less than or equal to 147 mm. The storage space (6) is provided with a first opening (61) on one side to facilitate the massage head (4) and cable through it. The storage space (6) is elastic and fastened to the outer circumference of the massage head (4).

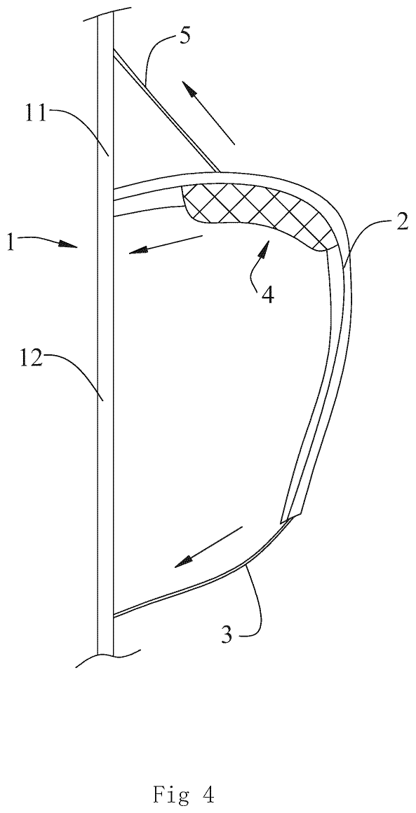

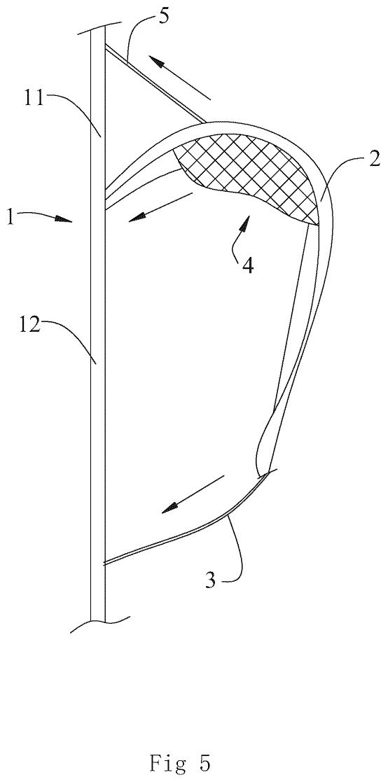

The working principle and process of this implementation are as follows. As shown in FIGS. 1-5, wherein the connection position of shoulder straps 2 and the back panel 1 will divide its back panel 1 into the upper part 11 and lower part 12, and the lower part 12 connected with the first webbing 3 is mainly used to adjust the position of backpack to fit on the human body, while adjusting the massage head 4 and the general position of the human shoulder and back, tighten the second webbing 5 can further adjust the massage head 4 on right position of human shoulder position, while the second webbing 5 provide the shoulder straps 2 upward tilting pulling force as shown in FIGS. 4-5, while under the gravity of the backpack, the ends of the shoulder straps are also pulled, so that the massage head 4 and the shoulder fully fit closely, to enhance the massage experience of the user in the case of backpack. Among them, the size of the innovative d is crucial to the closeness of the massage head.

Implementation II. As shown in FIGS. 1-5, a massage backpack, comprises a snug and adjustable massage structure described in implementation I and a bag body connected thereto, wherein the bag body being fixedly or detachably connected to the back panel.

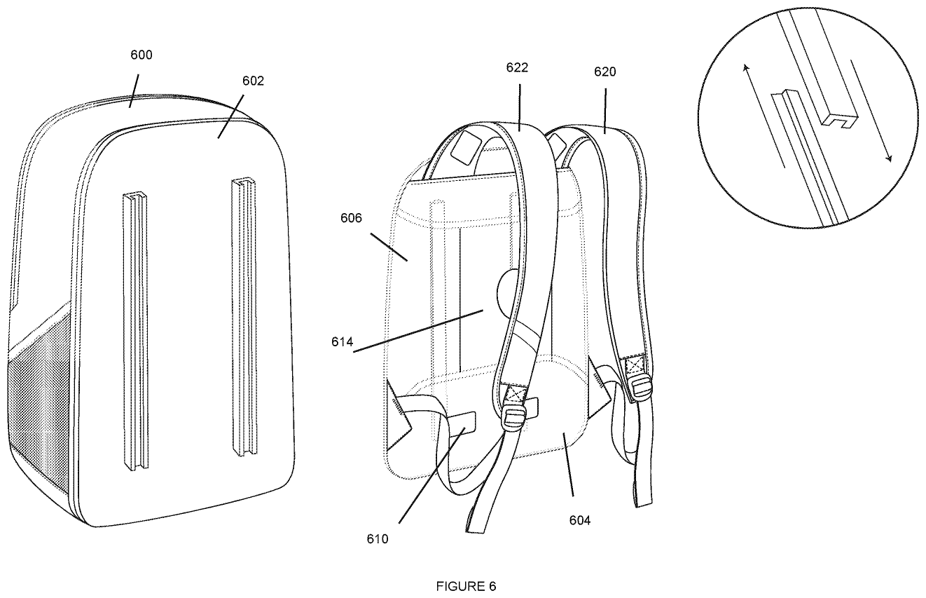

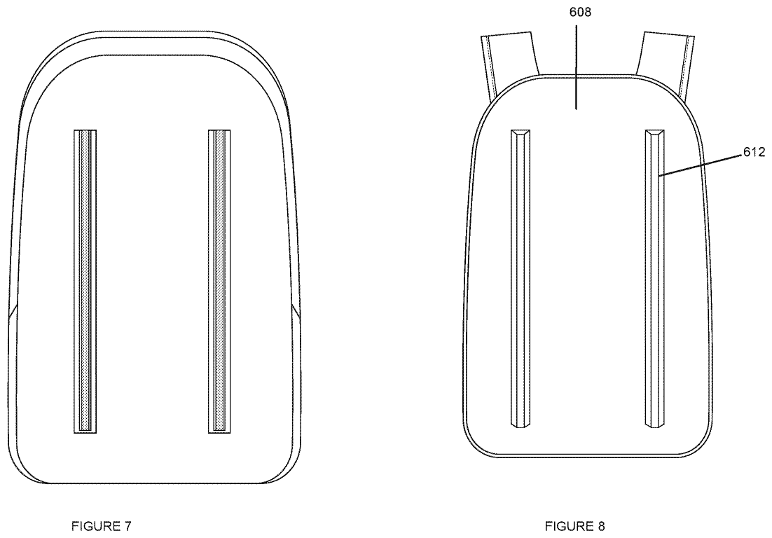

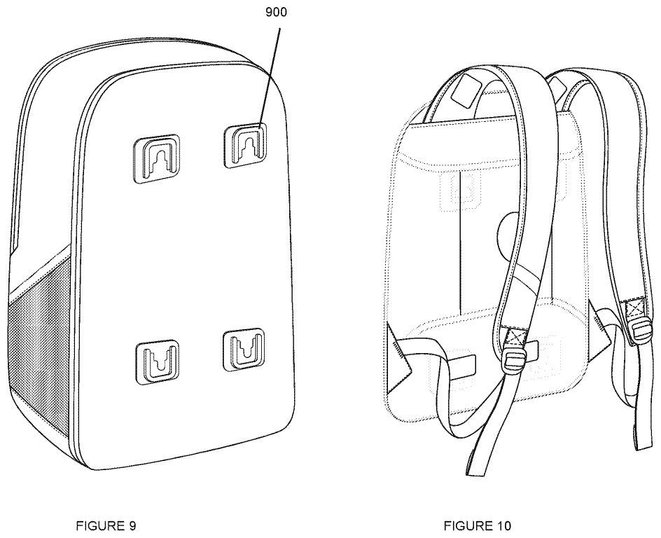

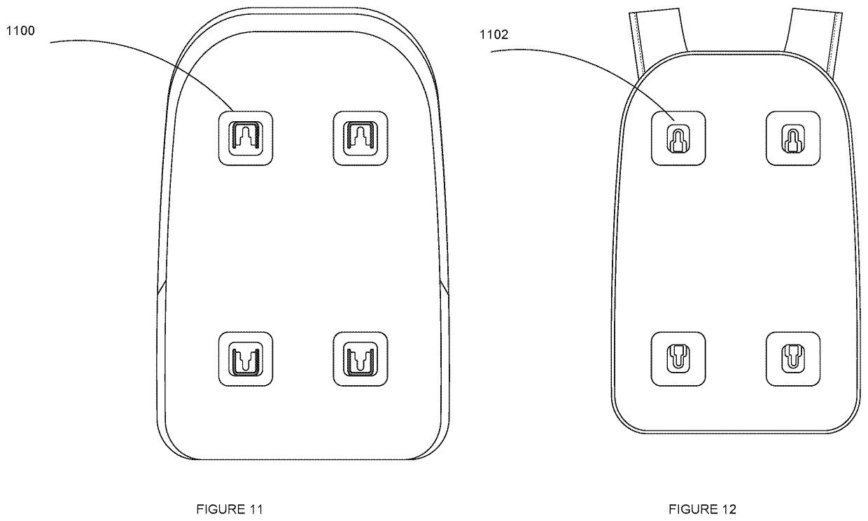

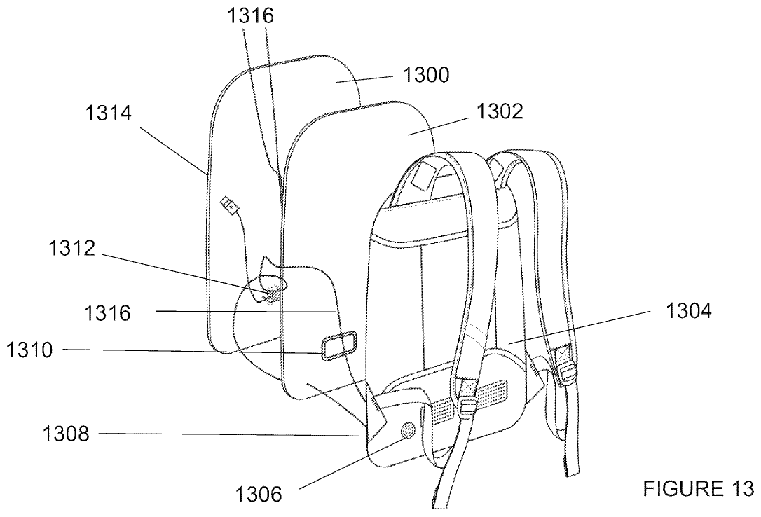

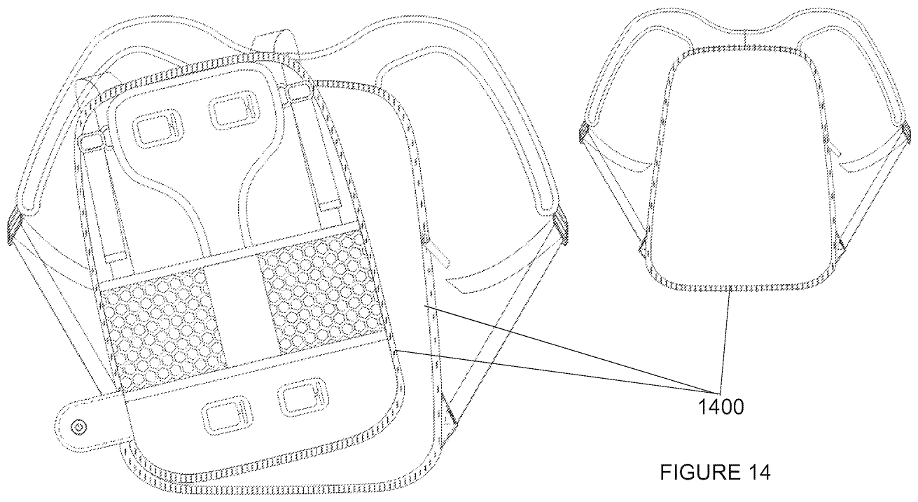

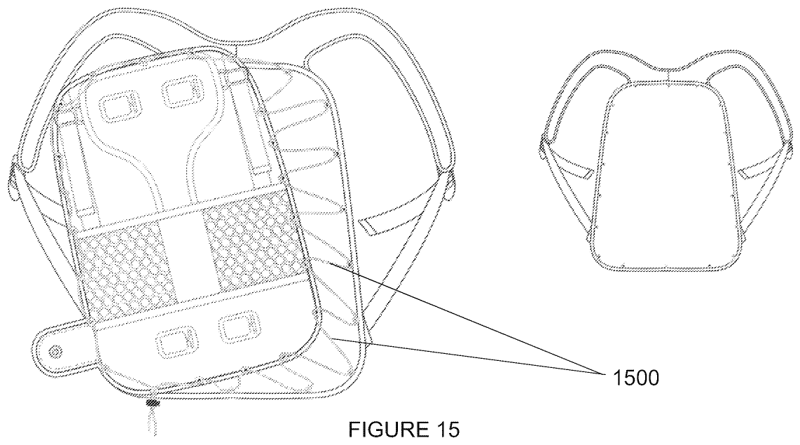

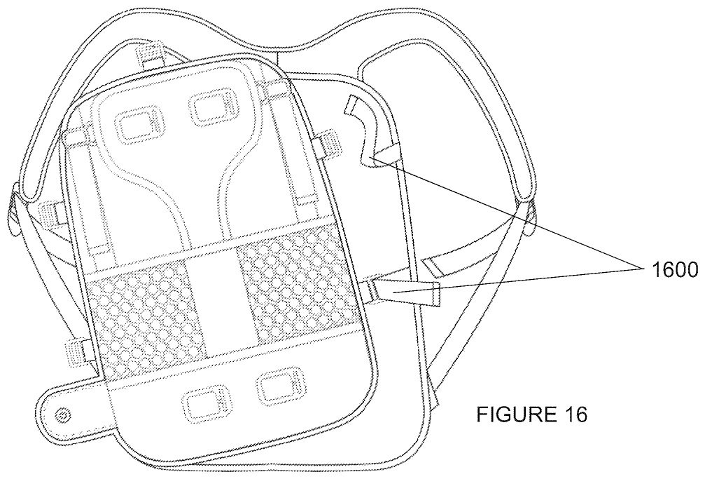

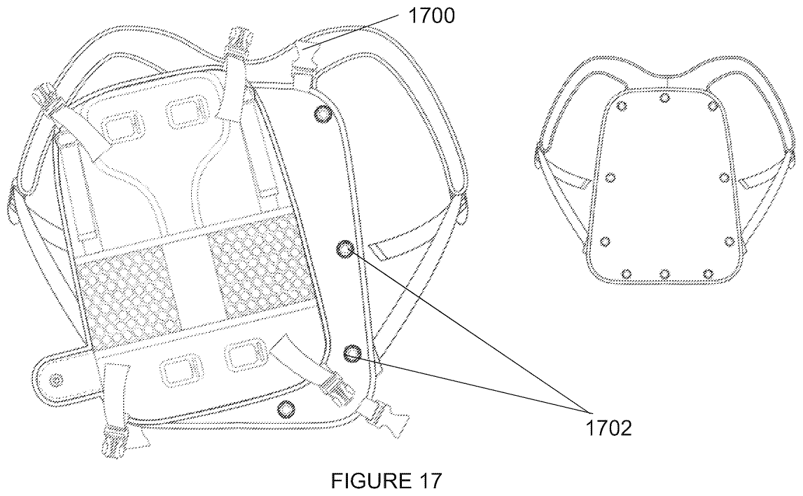

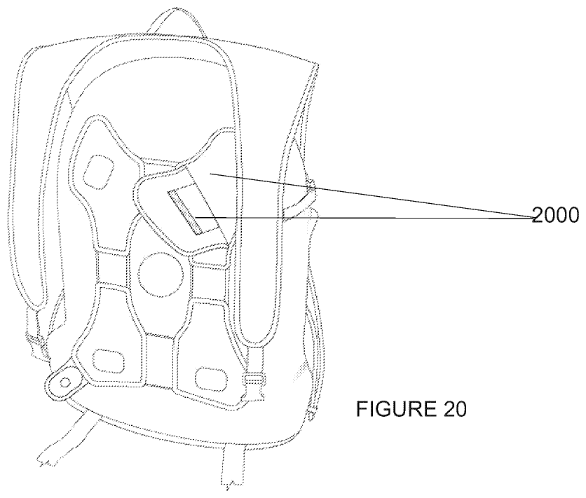

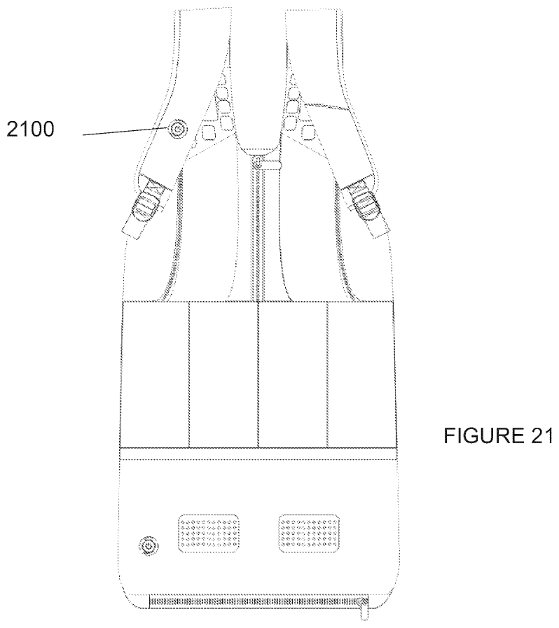

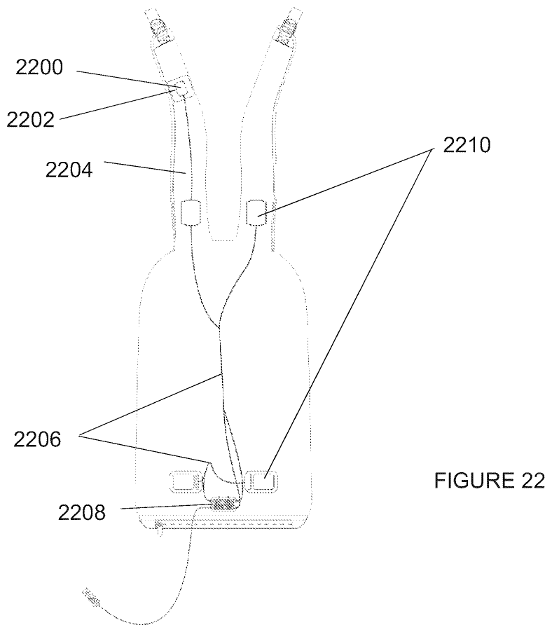

With reference to FIGS. 6, 7, 8, 9, 10, 11, 12, 13, 14, 15, 16, 17, 18, 19, 20, 21 and 22. A massaging apparatus system with a convenient manufacturing and removable structure, comprising, a body (600) with a first back panel (602), a second massage back panel (604), the second massage back panel is removable and attachable to the first back panel, wherein the second massage back panel has a first inner layer (1308), a second inner layer (1300), a first outer layer (606, 1304) and a second outer layer (608, 1314), wherein the second massage back panel has at least one massage head (610, 1310), wherein the first outer layer (606) is configured to communicate with a user's back for massage performance, the second outer layer (608) is configured to attach to the first back panel by at least a pair of detachable accessories (e.g. 612), wherein the second massage back panel is flexible, wherein between the first inner layer and the second inner layer there is at least one layer of flexible material (614) to protect the inner massage apparatus inside, to improve the comfort to the user and to achieve the effect that the user can fit apparatus more closely to their body, wherein a control circuit (1312) having at least one cable (1316) connects to the at least one massage head (1310, 2210). The detachable accessories may be selected from the group consisting of track, buckles (1700), hook and loop (2000) (Velcro®), webbing (1600), rope, straps (1500), slots, power stickers, magnets, buttons (1702), zippers (1400). Note that rope and strap are depicted by (1500) and (612) is a slot or track and (900, 1100, 1102) are buckles. FIGS. 11 and 12 depict an example of detachable accessories (1100, 1102). The detachable accessories may be flexible to achieve the effect that the user can fit the second massage back panel very closely to their own body. The control circuit is stored between the first inner layer and the second inner layer of the second massage back panel.

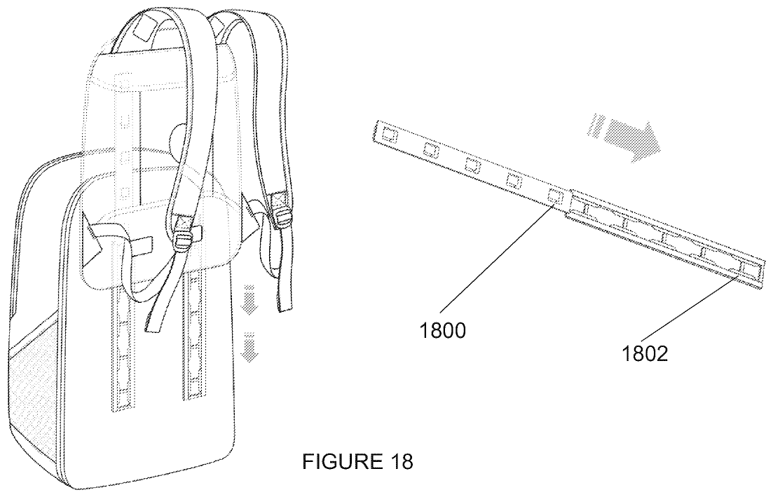

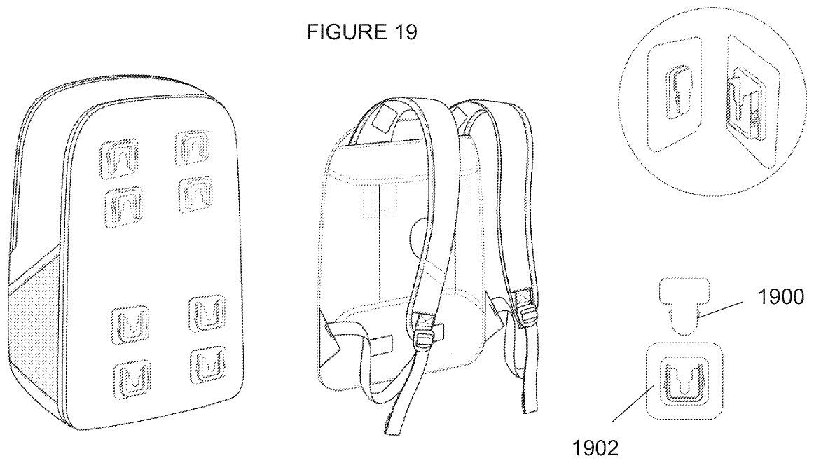

The second massage back panel may have at least one shoulder strap (620, 622, 2204). There may be a function control board (1306, 2100, 2200) in communication with the control circuit (2208). The function control board (2200) may be connected to the control circuit (2208) by a cable (2206). The function control board may be fixed on the body with a substantially rigid material base (2202) to keep it firmly in place. The function control board may be settled on the shoulder strap. The flexible material may be selected from the group consisting of metal, elastic fabric, foamy material, neoprene, rubber, silica, leather, leatherette, synthetic. There may be a pair of accessories that have a blocking system, wherein the blocking system prevents the accessories from being taken off unless the blocking system is released. FIG. 18 depicts an example of a slot with a blocking system (1800, 1802) that prevents accessories from being taken off unless the blocking system is released. FIG. 19 depicts another example of a blocking system that prevents the accessories from being taken off. As can be seen there is a base portion (1902) and a panel portion (1900) and the panel portion (1900) clicks into the base portion (1902) to provide a second massage back panel that is removable and attachable to the first back panel. When the pair of accessories are tracks or slots or buckles, there is one or more activity convex points on the male part of blocking system, and one or more activity convex points release button on the female part of the blocking system, when the pair of accessories are combined with each other and the male part slides downward, this activity convex points is movable, when the male part is pushed downward, the activity convex points on the blocking system will retract, so that the male part can slide downward directly smoothly to reach the position it should reach. When the male part of the accessory slides upward in the opposite direction, the activity convex points on the blocking system will not retract, and then the male part of the accessory will not come out automatically easily. It is necessary to manually press the activity convex points release button on the female part of accessory to make the activity convex points retract in order to remove the male part. This can make the massage back piece, while in use, will not easily move to wrong position or taken off.

The first back panel has more accessories (900) for the second massage back panel to attach to and configured for users to select the most suitable position for massaging. There may be a foam material (1302) with a thickness of at least 1 mm (this has been tested and determined to be the minimum thickness required to protect the massage apparatus) and attached between the first inner layer and the massage head. There may be a foam material with a thickness of at least 1 mm attached between the massage apparatus and the massage head. The first back panel is flexible to achieve the effect that the user can fit the body very closely to their own body.

### DESCRIPTION OF CERTAIN REFERENCE NUMBERS

1—back panel, 11—upper part, 12—lower part, 2—shoulder straps, 21—second opening, 3—first webbing, 31—first adjustment part, 4—massage head, 5—second webbing, 51—second adjustment part, 52—upper stitching, 53—lower stitching, 54—protruding section, 55—upper section, 56—a lower section, 6—storage pocket, 61—first opening, 7—fastening part, 8—fasteners.

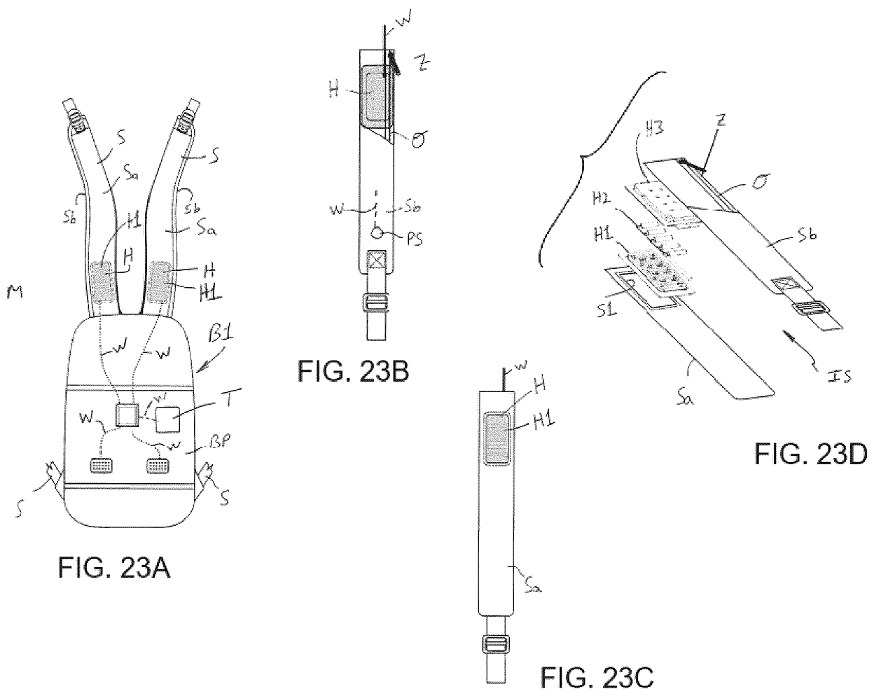

FIGS. 23A-23D (sometimes generally referred to as FIG. 23) illustrate a wearable luggage body shown as a backpack B1 including at least one shoulder strap S. The shoulder strap S includes an inside surface Sa oriented toward the body of a wearer when in use and includes an opposite outside surface Sb that is oriented outwardly away from the body of a wearer when in use. Each shoulder strap S can include one or more massage heads H inside an internal space IS (or “tunnel”) of the shoulder strap S defined between the inside and outside surface Sa,Sb. One or more massage heads H can also optionally be located in other locations of the backpack B1 such as adjacent the back panel BP as shown. Each massage head H is connected by a wire or wires W to an electronic control board M (referred to as a “mainboard”) that is located within the backpack B1 and is also connected by a wire or wires W to a battery T directly and/or through the mainboard M that is also located within the backpack B1. A power switch PS is connected to the shoulder strap S or other location of the backpack B1 and is connected by a wire W or wireless connection to the control board M and is selectively operably by a user to activate and/or deactivate the massage head(s) H which pulsate and/or vibrate when activated and supplied with electrical power from the battery T as controlled by the control board M. Alternatively, the mainboard control board M can be wireless connected to a mobile phone that can be used to activate the massage heads H. As shown in the exploded view of FIG. 23D, each massage head H can include a soft, flexible silicone massage pad H1 that is located in and/or positioned to be exposed through in an opening S1 that is defined in the inside surface Sa of the shoulder strap S. Each massage head H also includes a vibrator H2 located adjacent the silicone massage pad H1 that provides massage pulse and/or vibration forces to the silicone massage pad H1. Each massage head H also includes a massage head cover H3 that is positioned over the vibrator H2 so that the vibrator H2 is located between the cover H3 and the silicone massage pad H1. The outside surface Sb of the shoulder strap S can cover the massage head cover H3 and can include an access opening O with a zipper Z or other closure element such as a hook and loop (Velcro) closure element so that the opening O provides selective access to the interior space IS inside the shoulder strap S where the massage head H is operatively located between the inside and outside surfaces Sa,Sb for insertion and/or removal of the massage head H relative to the internal space IS of the strap S for ease of repair or replacement of the massage head H. Each cable or wire W connected to the massage heads H, the control board M, the battery T, and/or the power switch PS can include a releasable plug/socket or other quick connector to facilitate connection and disconnection of the massage heads H, control board M, battery T, and/or power switch PS for repair or replacement. The silicone massage pad H1 exposed through the opening S1 in the inside surface Sa of the shoulder strap S provides good and comfortable transmission of the massage forces from the vibrator H2 to the body of the wearer of the backpack B1 and the silicone massage pad H1 is soft and flexible to provide improved comfort the wearer while also being extremely durable and resistant to moisture, liquids, food/drink spills, rain, and other contaminants.

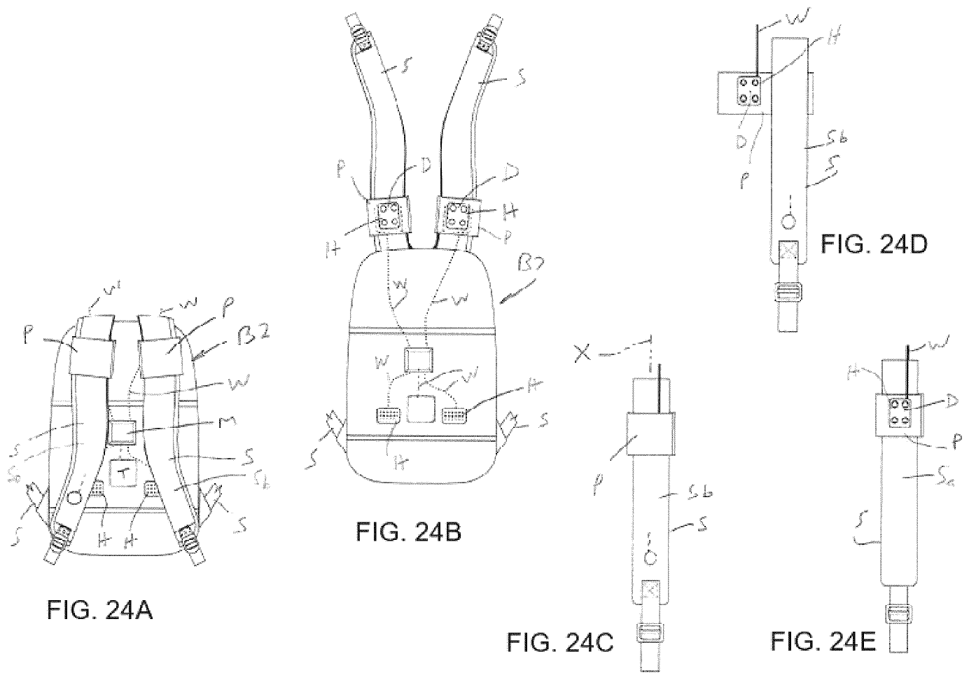

FIGS. 24A-24E (sometimes generally referred to as FIG. 24) illustrate a wearable body shown as a backpack B2 including at least one shoulder strap S. Except as otherwise shown and/or described, the backpack B2 and components thereof is/are the same as the backpack B1 as described above and are not necessarily described here again, and like reference numbers/letters are used in FIG. 24 to indicate like components relative to the backpack B1. The shoulder strap S includes an inside surface Sa oriented toward the body of a wearer when in use and includes an opposite outside surface Sb that is oriented outwardly away from the body of a wearer when in use. Each shoulder strap S can include one or more massage heads H connected to a movable annular or ring-shaped “cuff” or patch P that is slidably connected to and encircles the shoulder strap S so as to be slidable along a longitudinal axis X of and movable relative to the should strap S to adjust the position of the massage head H on the shoulder strap S so that the user/wearer of the backpack B can adjust the position of the massage head H to a desired massage position. As described above, the massage heads H are connected by wire or cable W to the mainboard M and battery T and can be controlled by the power switch PS and/or by a wireless connection. Each massage head H can include a drum D that is located on the patch/cuff P that provides the massage pulses and/or vibrations to the body of the user/wearer of the backpack B2 when the massage head H is activated. As noted above, the patch P can be slid along the longitudinal axis X of the strap S to adjust the location of the patch P on the strap S. Also, each movable patch P can be selectively rotated about the strap S (i.e., about a longitudinal axis X of the strap S) so that the massage head H can be selectively positioned in either: (i) a first or operative position where the massage head H is positioned in a first arrangement on said shoulder strap S adjacent the inside strap surface Sa with the massage head drum D oriented toward a body of an associated user/wearer of the backpack or other wearable body for providing massage pulses and/or vibrations to the body of the user/wearer when the massage head H is activated; (ii) a second or inoperative position where the massage head H is positioned in a second arrangement on said shoulder strap and located adjacent the outer strap surface Sb with the massage head drum D oriented away from the body of an associated user/wearer of the backpack B2 so that the massage head H (massage head drum D thereof) does not dig into or crush the user's body and otherwise exert undesired forces on the user's body when the massage head H is not in use (deactivated) as can lead to discomfort, especially if the backpack B2 is heavily loaded.

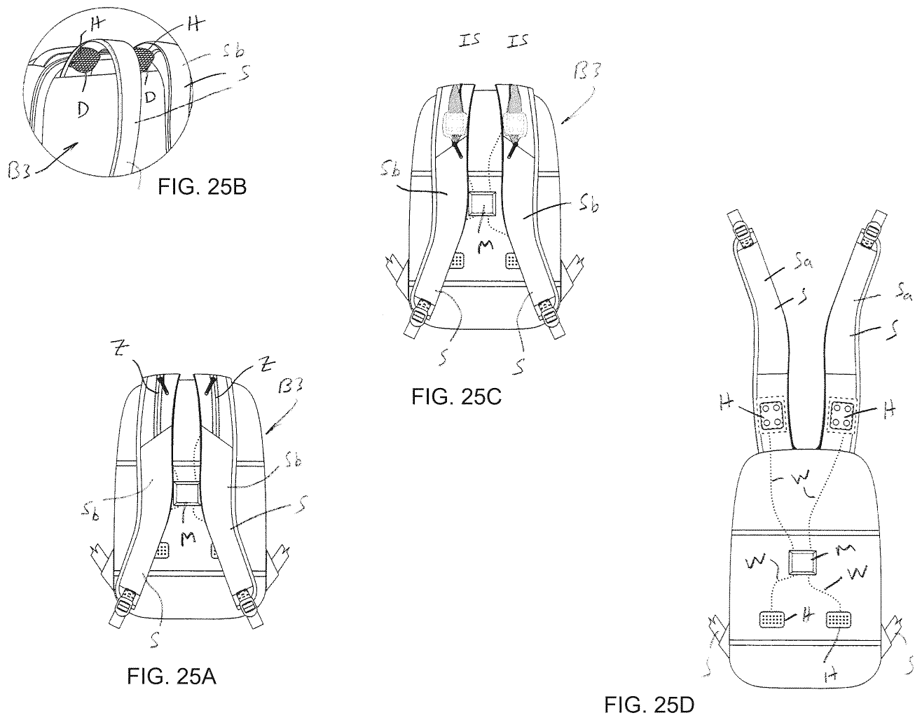

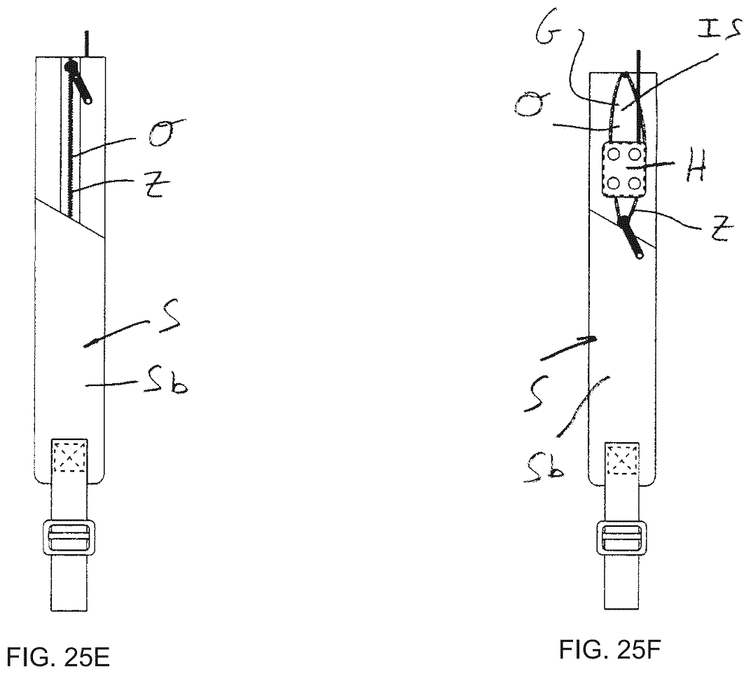

FIGS. 25A-25F (sometimes generally referred to as FIG. 25) illustrate a wearable body shown as a backpack B3 including at least one shoulder strap S. Except as otherwise shown and/or described, the backpack B3 and components thereof is/are the same as the backpack B1 as described above and are not necessarily described here again, and like reference numbers/letters are used in FIG. 25 to indicate like components relative to the backpack B1 (the power switch PS and battery T are not shown in FIG. 25). The shoulder strap S includes an inside surface Sa oriented toward the body of a wearer when in use and includes an opposite outside surface Sb that is oriented outwardly away from the body of a wearer when in use. Each shoulder strap S can include one or more massage heads H located in an internal or interior space IS of the shoulder strap S that is defined between the inside and outside strap surface Sa,Sb. Each massage head H includes a massage head drum D that is located adjacent and/or exposed through the inside surface Sa of the strap that provides the massage pulses and/or vibrations to the body of the user or wearer of the backpack B3 when the massage head H is activated. The shoulder strap S can include an opening (or fold of material or “pleat”) O in the strap outside surface Sb that is selectively opened or closed by a zipper Z or hook and loop (Velcro) fastener or similar. When the zipper Z or other fastening element is closed (in a first position) the massage head H is constrained in the interior space IS and exerts a strong force through the inside strap surface Sa onto the body of the user/wearer. In contrast, when the zipper Z or other fastening element is opened (in a second position), a relief space or gap G is created to allow the massage head H to move away from the strap inside surface Sa (away from the user's body) toward the strap outside surface Sb so that the massage head H presses onto the body of the user with less force as compared to the first (closed) position of the zipper Z or other fastening element. The zipper Z or other fastening element can be positioned at an intermediate position between the first (closed) and second (opened) positions so that the massage head H provides an intermediate amount of force on the user's body.

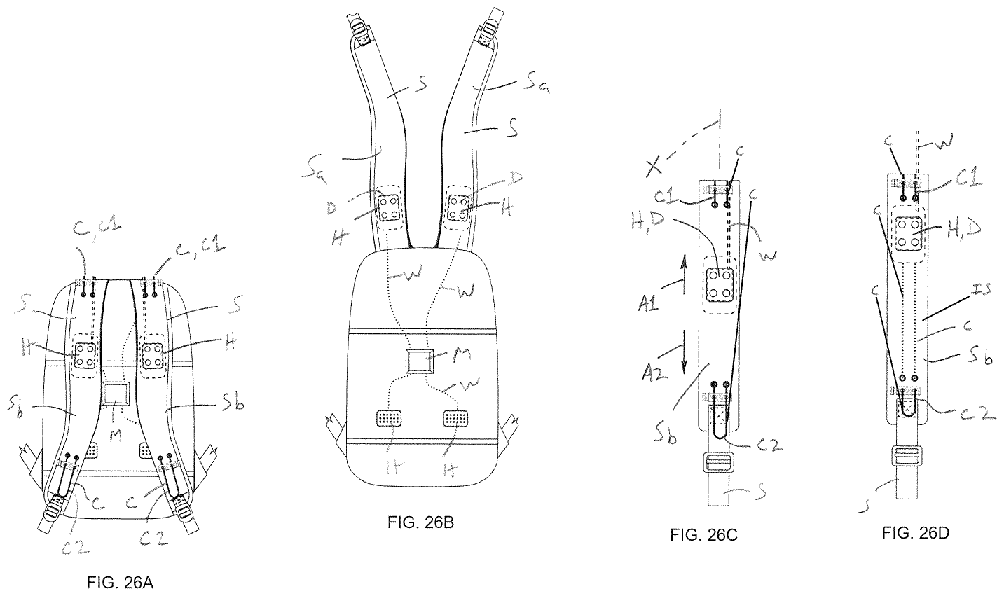

FIG. 26A-26D (sometimes generally referred to as FIG. 26) illustrate a wearable body shown as a backpack B4 including at least one shoulder strap S. Except as otherwise shown and/or described, the backpack B4 and components thereof is/are the same as the backpack B1 as described above and are not necessarily described here again, and like reference numbers/letters are used in FIG. 26 to indicate like components relative to the backpack B1 (the power switch PS and battery T are not shown in FIG. 26). The shoulder strap S includes an inside surface Sa oriented toward the body of a wearer when in use and includes an opposite outside surface Sb that is oriented outwardly away from the body of a wearer when in use. Each shoulder strap S can include one or more massage heads H located in an internal or interior space IS of the shoulder strap S that is defined between the inside and outside strap surface Sa,Sb (the interior space is also sometimes referred to as a “tunnel”). Each massage head H includes a massage head drum D that is located inside the interior space adjacent the inside surface Sa of the strap that provides the massage pulses and/or vibrations to the body of the user or wearer of the backpack B3 when the massage head H is activated. As described above, the shoulder strap S can include an opening in the strap insider or outside surface Sa,Sb that is selectively opened or closed by a zipper or hook and loop (Velcro) fastener or similar to allow for replacement of the massage head H. The massage head H is slidably movable inside the interior space along a longitudinal axis X of the strap S in first and second opposite direction A1,A2 so that the user can manually adjust the position of the massage head H along the axis X of the strap S to control the region of the user's body that is being impacted or engaged by the massage head H. At least one rope or cord C (one or more ropes or cords C) is/are connected to the massage head H. Part of each cord C is located outside of the interior space (tunnel) IS of the shoulder strap S and can be selectively manually pulled by a user/wear to move the massage head in the first and/or second direction A1,A2 to change a position of the massage head H within the tunnel. In one example as shown, a first rope or cord C1 is connected to the massage head H on a first side or in a first orientation to move the massage head H in the first direction A1, and a second rope or cord C2 is connected to the massage head H on a second side or in a second orientation to move the massage head H in the second direction A2. In the illustrated example, the cord(s) C (C1,C2) can exit the interior space (tunnel) IS through or adjacent the outside strap surface Sb so as to be readily accessible to the user/wearer of the backpack B4.

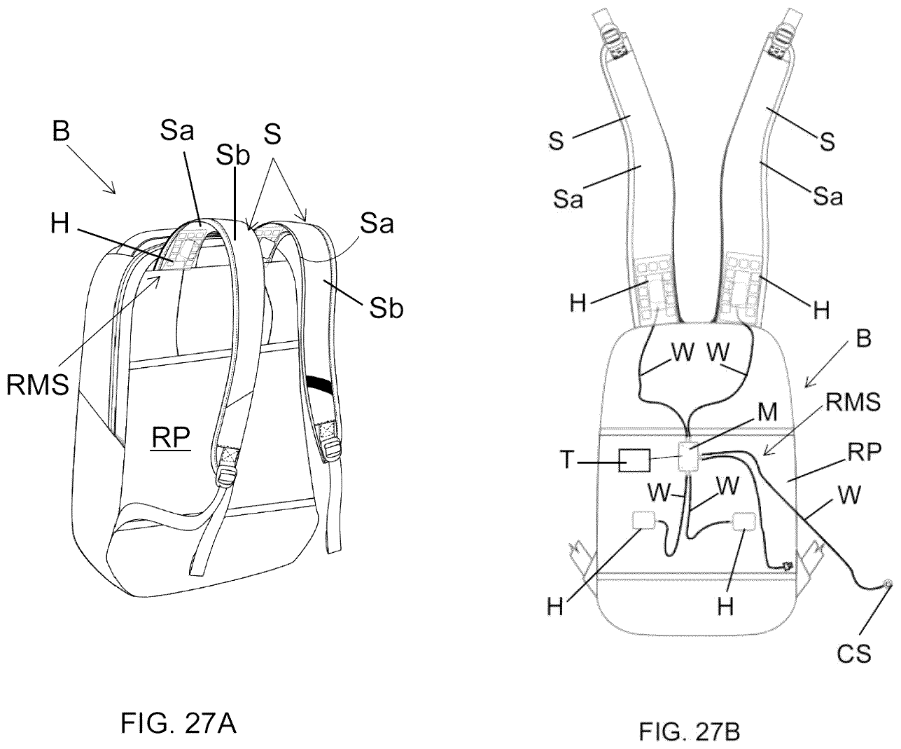

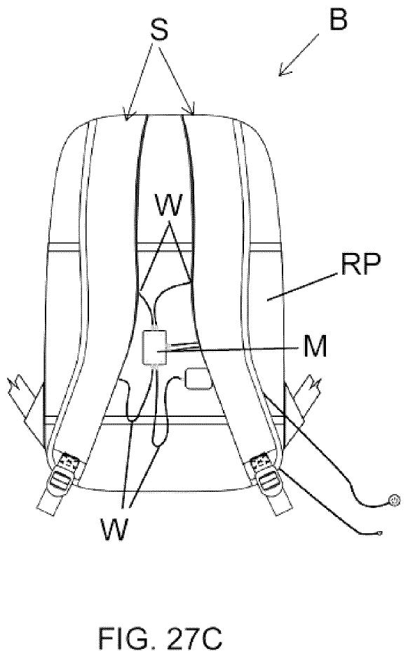

FIG. 27A illustrates a wearable luggage body shown as a backpack B (wearable body) configured to be worn on a user's torso and to bear a load, thereby applying pressure to the user's torso. The backpack B includes a removable massage system RMS detachably integrated with the backpack B as described below. The backpack B includes at least one shoulder strap S (as shown the backpack B includes first (left) and second (right) shoulder straps S. Each shoulder strap S includes an inner surface Sa oriented toward the body of a wearer when in use and includes an opposite outer surface Sb that is oriented outwardly away from the body of a wearer when in use. The removable massage system is provided with at least one pair of a detachable accessory, enabling the entire removable massage system to be detached from the wearable body as a single, complete unit. The detachable accessory can include, for example, Velcro, a zipper, a band, tape, snaps, a button, a strip, and/or a sticker.

With reference also to FIGS. 27B & 27C, each shoulder strap S can include one or more massage heads H removably connected to the respective shoulder strap S, and each such massage head H will lie adjacent a user's/wearer's shoulder when the backpack is in use being worn. The backpack B can also include one or more massage heads H optionally removably located in other locations of the backpack B such as adjacent a rear panel RP that lies adjacent a user's/wearer's back when the backpack is being worn in use. The at least one massage head H is structurally integrated with the backpack B via the detachable accessories to form a force-coupling interface, enabling transmission of mechanical forces between the backpack B, the user's torso, and the massage head H.

Each massage head H is connected by a wire or wires W to an electronic control system or control board M (referred to as a “mainboard”) comprising a microcontroller unit (MCU) that is removably connected to the backpack B1 and is also connected by a wire or wires W to a battery T directly and/or through the mainboard M that can also be part of the removable massage system RMS that can be selectively connected to and removed from the backpack B. The removable massage system RMS further comprises a control switch CS removably connected to the shoulder strap S or other location of the backpack B1 and is connected by a wire W or wireless connection to the control board M and is selectively operably by a user to activate and/or deactivate and/or otherwise control the massage head(s) H which pulsate and/or vibrate when activated and supplied with electrical power from the battery T as controlled by the control board M. Alternatively, the mainboard M can be wirelessly connected to the power switch and/or to a mobile phone or other wireless control device that can be operated by the user to activate all of the massage heads H or some subset of any one or more of the massage heads H. A microphone MK for voice input can be provided as part of the removable massage system RMS and connected by a wire or wirelessly to the mainboard M to provide input of voice commands to the mainboard M whereby the microphone MK can receive voice input commands from a user/wearer to turn on or turn off all or some subset of the massage heads H. The microphone MK can alternatively be provided by the microphone of a mobile phone that is connected by a wired or wireless connection such as Bluetooth to the mainboard M.

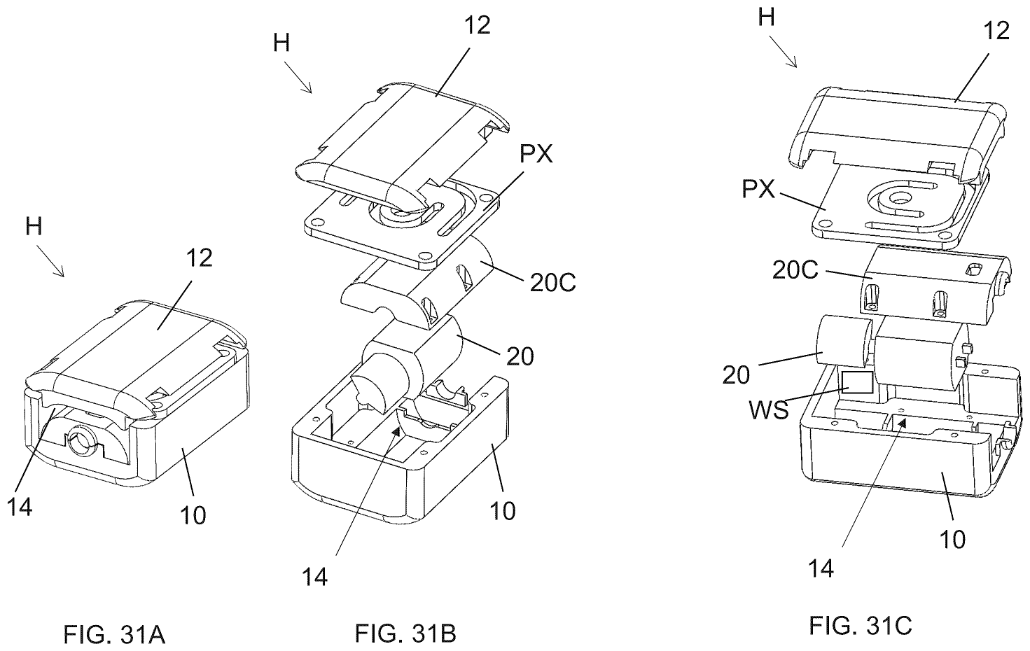

As described in more detail below, each massage head H includes a vibrator actuator or oscillator such as a crystal oscillator that provides massage pulse and/or vibration forces to the body of the user/wearer. The crystal oscillator is configured to provide a stable clock signal to the MCU. As is also described further below, each massage head H can include a pressure sensor PX (see FIGS. 31B & 31C) that detects a pressure exerted on the massage head H by the wearer's body (and vice versa) wherein the detected pressure is used to control operation of the massage head H such as any one or more of: enabling or disabling operation or activation of the massage head H based upon the detected pressure; increasing or decreasing the massage oscillation intensity (magnitude) and/or frequency based upon the detected pressure. The detected pressure can be input to the mainboard M for use by the mainboard M to control the massage head H as noted, and/or the detected pressure can alternatively be used within the massage head H directly (without being communicated to the mainboard M) for control the massage H as noted. The pressure data detected by each pressure sensor PX can also be recorded by the mainboard M and/or by a wirelessly connected smartphone for analysis and display to a user or other person such that the user can be aware of the pressure exerted on the user's body over time. The other massage heads H not in a strap (such as the massage heads H located adjacent the rear panel RP) can be similarly structured and can also each include a pressure sensor PX as described above and additionally below. The removable massage system RMS has a line port (not shown) located between an upper cover and a lower cover of the oscillator crystal, and the line port is connected to a power supply to complete a power supply operation.

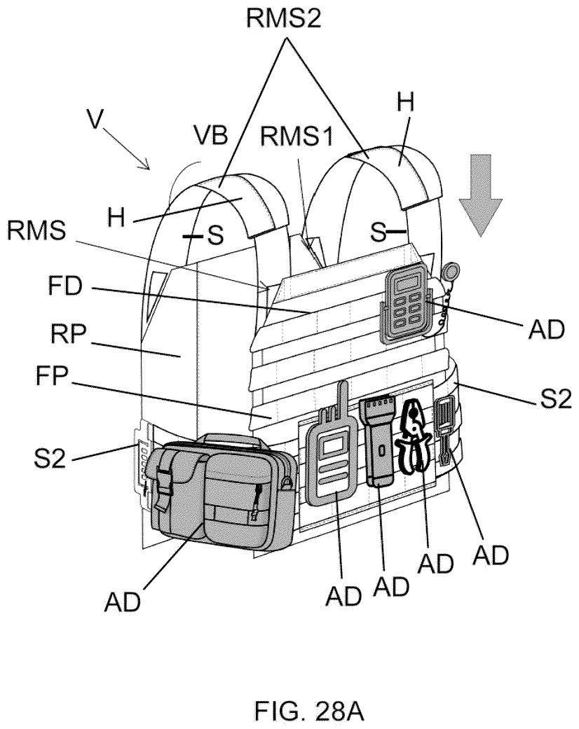

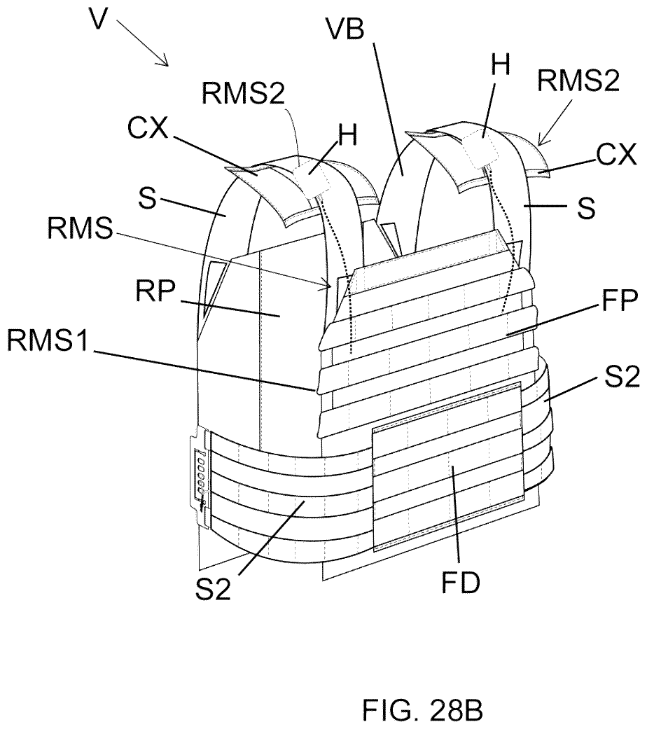

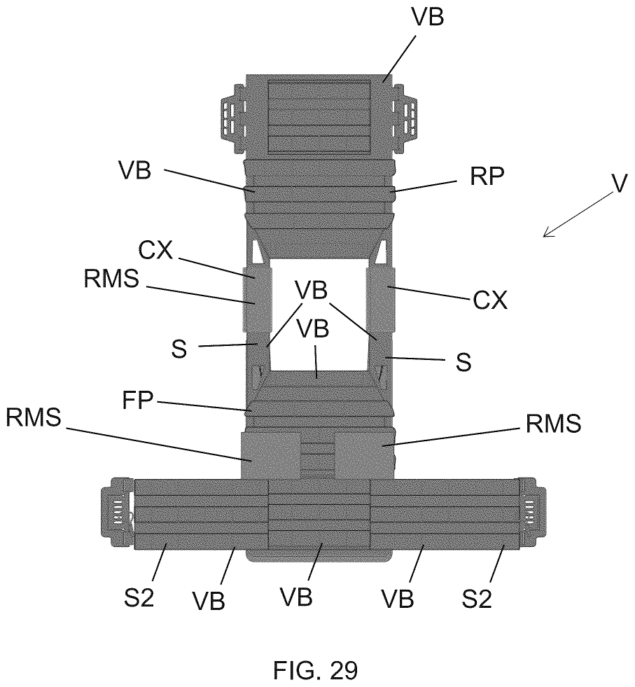

The removable massage system RMS can use Velcro (hook and loop) fastening elements, clips, straps, snaps, zippers, and/or other fasteners for selectively connecting the components of the removable massage system RMS to the backpack B, in particular, to the straps S and the rear panel RP of the backpack B (i.e., in corresponding first and second parts of at least one storage space of the backpack B). As described below, the wearable body B of the backpack can be replaced by a wearable body comprising a vest V (see FIGS. 28A, 28B, and 29).

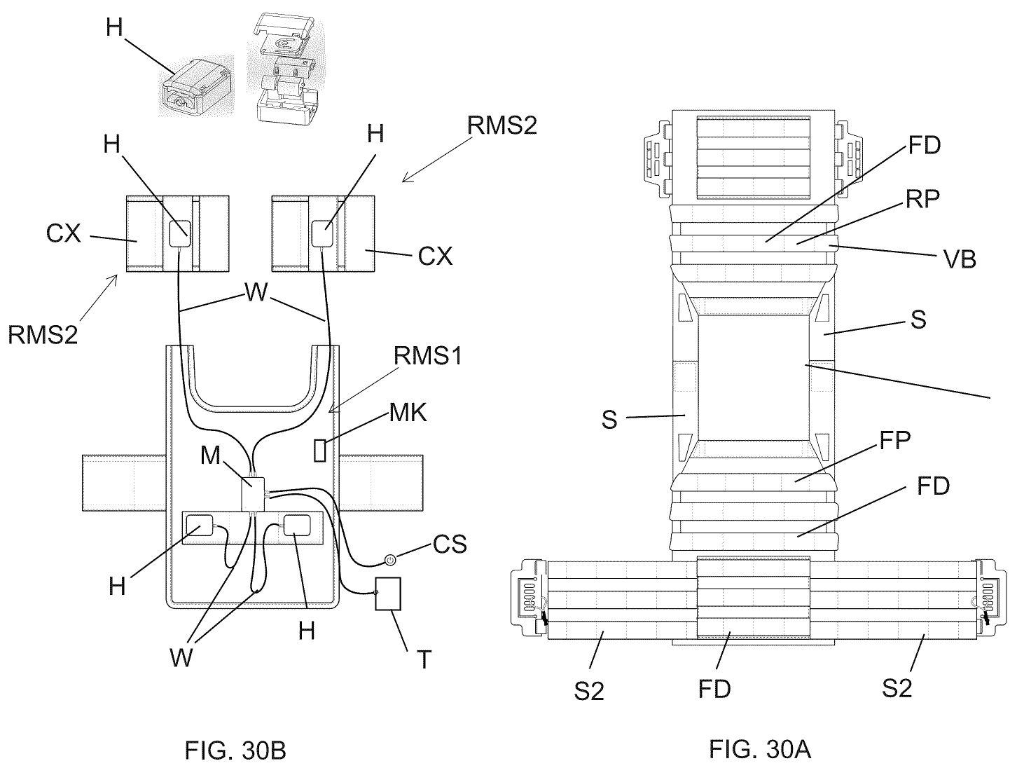

FIGS. 28A, 28B, and 29 illustrate an embodiment of a wearable vest (wearable body) V including a removable massage system RMS in accordance with another aspect of the present development. FIGS. 30A and 30B show the vest V of FIG. 29 separated into its main components including a vest body VB (on the right side of the drawing) and a removable massage system RMS (on the left side of the drawing, including first and second portions RMS1,RMS2) that is selectively connected to the vest body VB. The wearable vest V includes a vest body VB comprising a front panel FP, a rear panel RP, and first (left) and second (right) shoulder straps S that extend between and connect the front panel FP and the rear panel RP. In use when worn by a user, the front panel FP can lie adjacent a wearer's chest, the rear panel RP can lie adjacent the wearer's back, and the shoulder straps S can extend over the left and right shoulders of the wearer and interconnect and extend between the front and rear panels FP,RP. The front and rear panels FP,RP can also be connected in use by side straps S2 of the vest body VB.

The front panel FP and also optionally the rear panel RP includes Velcro (hook and loop fastening elements), clips, snaps, magnets, adhesive zones, and/or other fastening devices FD for selectively attaching tools, mobile phones, radios, weapons, and other accessory devices AD to the front panel FP and/or rear panel RP for selective use and/or detachment by the wearer. In FIG. 28B all of the accessory devices AD are removed from the vest V.

Unlike known wearable vests, the vest V comprises a removable massage system RMS that can be selectively connected to and disconnected from the vest base VB. With reference also to FIGS. 30A and 30B, the removable massage system RMS comprises: (i) a first portion RMS1 that is selectively releasably connected to the front panel FP of the vest and that includes at least one massage head H to be located adjacent the front panel FP when installed; and (ii) a second portion RMS2 that includes at least one and preferably at least two (first (left) and second (right)) removable massage heads H that are operably connected by wires W to the first portion RMS1 and that are selectively releasably connected respectively to the first (left) and second (right) shoulder straps S of the vest base VB. The first portion RMS1 or the second portion RMS2 can optionally comprise at least one massage head H to be removably installed adjacent the rear panel RP.

More particularly, the first portion RMS1 of the removable massage system comprises an electronic control board M (referred to as a “mainboard”) comprising a microcontroller unit (MCU) that is connected by wires to the removable massage heads H to control the massage heads H and to supply electrical power from a battery T to the massage heads H via a power supply disposed in a power storage space on the backpack B. The first portion RMS1 can comprise massage heads H in addition to those of the second portion RMS2 so that when the removable massage system RMS is operatively installed on the vest body VB, the massage heads of the first portion RMS1 are located adjacent to the front panel FP of the vest body VB (and optionally also adjacent the rear panel RP).

The first portion RMS1 of the removable massage system RMS can also comprise a battery T that can be connected by a wire or wires W to the mainboard M. A function control switch or control panel CS is provided as part of the first portion RMS1 (and/or second portion RMS2) and is connected by a wire W or wireless connection to the control board M and is selectively operably by a user to activate and/or deactivate and/or otherwise control the massage head(s) H of the removable massage system RMS which pulsate and/or vibrate when activated and supplied with electrical power from the battery T as controlled by the control board M. Alternatively, the mainboard M can be wirelessly connected to the control switch CS and/or to a mobile phone or other wireless control device that can be operated by the user to activate all of the massage heads H or some subset of any one or more of the massage heads H. The function control panel CS can include, for example, a voice integrated circuit (IC) configured as a microphone MK provided as part of the first portion RMS1 (and/or the second portion RMS2) and can be connected by a wire or wirelessly to the mainboard M or incorporated directly into the mainboard M to provide voice control input to the mainboard M whereby the microphone can receive voice input commands from a user/wearer to turn on or turn off all or some subset of the massage heads H and/or control the amplitude and frequency of the oscillation of the massage heads H. The microphone MK can alternatively be provided by the microphone of a mobile phone that is connected by a wired or wireless connection such as Bluetooth to the mainboard M. The function control panel CS has a multi-mode selection function, selectable from the group consisting of: switch button control, voice wake-up, mobile device control, and a no-load automatic shut-off function

The removable first portion RMS1 can be selectively connected to the vest body by any one or more suitable connection fastening devices such as one or more buckles, snaps, clips, Velcro (hook and loop fastening elements), zippers, adhesive, straps, magnets and/or any other suitable fastening device(s). As shown Velcro hook and loop fasteners VF are used to selectively and releasably secure the first portion RMS1 to the front panel FP of the vest body VB.

The second removable portion RMS2 comprises at least one and preferably at least two (first (left) and second (right)) removable massage heads H that are operably connected by at least two wires W to the mainboard M of the first portion RMS1 and that are selectively releasably connected respectively to the first (left) and second (right) shoulder straps S of the vest base VB. More particularly, in the illustrated example, when the second removable portion RMS2 is operatively installed on the vest body VB, each shoulder strap S includes a removable massage head H that is releasably attached to the respective shoulder strap S in a desired location. Each removable massage head H can be releasably secured to its respective shoulder strap S using a cuff or other connector CX that can comprise a zipper, Velcro (hook and loop fastening elements), clips, snaps, magnets, adhesive, straps, and/or other fastening devices for selectively and releasably connecting the removable massage head H to the respective shoulder strap S. FIG. 2B shows the removable massage head connectors CX in an open or disengaged position in which the removable massage head H secured thereby can be separated from or installed on the strap S. When each massage head connector CX is moved to its operative closed or engaged position as shown in FIG. 2A, the removable massage head H is operatively connected to the respective shoulder strap S.

Each massage head H of the removable massage system RMS (including the first portion RMS1 & second portion RMS2) is connected by wire W to the “mainboard” M comprising a microcontroller unit (MCU) that is provided as part of the removable massage system (part of the first portion RMS1 in the illustrated example). Each massage head H is also connected by a wire W to a battery T directly and/or indirectly through the mainboard M. All of any one of the massage heads H can include a pressure sensor PX (see FIGS. 5B & 5C) that detects a pressure exerted on the massage head H by the wearer's body (and vice versa) wherein the detected pressure is used to control operation of the massage head H such as any one or more of: enabling or disabling operation or activation of the massage head H based upon the detected pressure; increasing or decreasing the massage oscillation intensity (magnitude) and/or frequency based upon the detected pressure. The pressure detected by the pressure sensor PX can be input to the mainboard M for use by the mainboard M to control the massage head H as noted, and/or the pressure sensed by the pressure sensor can be used within the massage head H directly (without being communicated to the mainboard M) for control the massage H such as on/off functions and/or variation of oscillation force of the massage head H. The pressure data detected by each pressure sensor PX can also be recorded by the mainboard M and/or by a wirelessly connected smartphone for analysis and display to a user or other person such that the user can be aware of the pressure exerted on the user's body over time. In some examples, the MCU is programmed to select an operational massage mode for the massage head H based on the detected pressure such that a) a first massage mode is selected when the detected pressure corresponds to a load of less than 1.6 kg; a second massage mode, distinct from the first massage mode, is selected when the detected pressure corresponds to a load greater than or equal to 1.6 kg and less than 3.2 kg; and a third massage mode, distinct from the first and second massage modes, is selected when the detected pressure corresponds to a load greater than or equal to 3.2 kg. The first massage mode comprises a high-frequency micro-vibration operating at a duty cycle configured to be between 40% and 60%, the second massage mode comprises a medium-frequency micro-vibration operating at a duty cycle configured to be between 30% and 50%, and the third massage mode comprises a low-frequency micro-vibration operating at a duty cycle configured to be between 20% and 40%. The duty cycle for each massage mode is implemented in a 2-second operational cycle.

FIGS. 31A-31C illustrate an example of a massage head H provided in accordance with an embodiment of the present development. FIG. 31A is an assembled isometric view of the massage head H, while FIGS. 31B & 31C provide respective exploded isometric views of the massage head H. In the illustrated non-limiting example, the massage head H can comprise a housing 10,12 including a base shell 10 and a top shell 12 that is selectively connected to and removable from the base shell 10. The housing components 10,12 can be molded polymeric structures or other materials. The base shell 10 and top shell 12, when operably connected as shown in FIG. 5A define a hollow interior space 14 in which a massage actuator 20 is installed. A massage actuator cover 20c can be provided within the space 14 to cover the massage actuator 20. The base shell 10 can be hollowed out and directly fits to the massage actuator 20. A surface of the massage actuator 20 is covered by a noise reduction material to reduce massage noise. The massage head H further comprises a pressure sensor PX within the space and located adjacent the top shell or otherwise positioned to sense pressure exerted on the top shell or other part of the massage head housing 10,12. The pressure sensor PC can be a MEMS pressure sensor, load cell, or any other suitable device for converting sensed pressure into an electronic output signal. As mentioned above, the pressure sensed by the pressure sensor PX can be used by the mainboard M and/or directly by the massage head H to turn the massage actuator 20 on or off, to increase the magnitude or frequency or other massage oscillation characteristics of the massage actuator 20, and/or to provide pressure feedback to the user/wearer of the vest V that can be recorded by the mainboard M and/or a connected smart phone or other device so that the user/wearer can review and track a history of pressure exerted by the vest V on the user's body over time for each individual massage head and/or an average pressure for any group of massage heads H. Each massage head H has an exterior part with a length not exceeding 45 mm and a width not exceeding 35 mm, and is in a shape of a rectangular or oval cylinder. Each massage head H can be made of plastic and assembled with the top shell 12, the pressure sensor PX, the massage actuator cover 20c, and the base shell 10 all assembled together via screws or glue. In some embodiments, the massage head H is configured with a miniature weighing sensor WS that adapts massage frequency based on detected pressure weight, thereby providing a personalized massage experience. In some embodiments, the removable massage system RMS has a line port located between an upper cover and a lower cover of the oscillator cover 20c, and the line port is connected to a power supply to complete a power supply operation. In some examples, the massage actuator 20 is a crystal-based piezoelectric device configured to generate mechanical vibrations for massage upon application of an electrical signal.

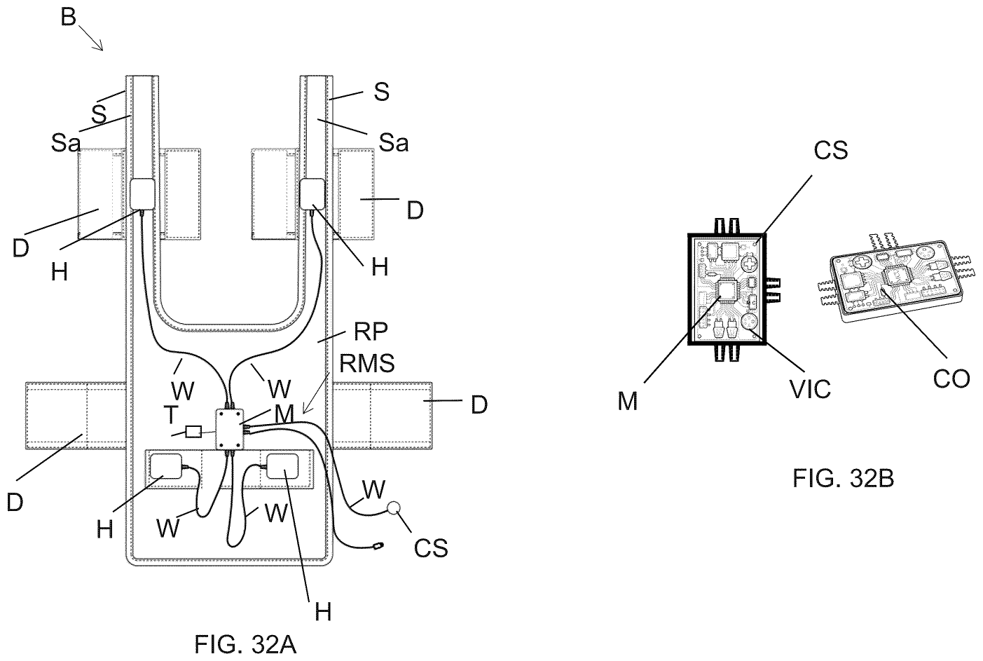

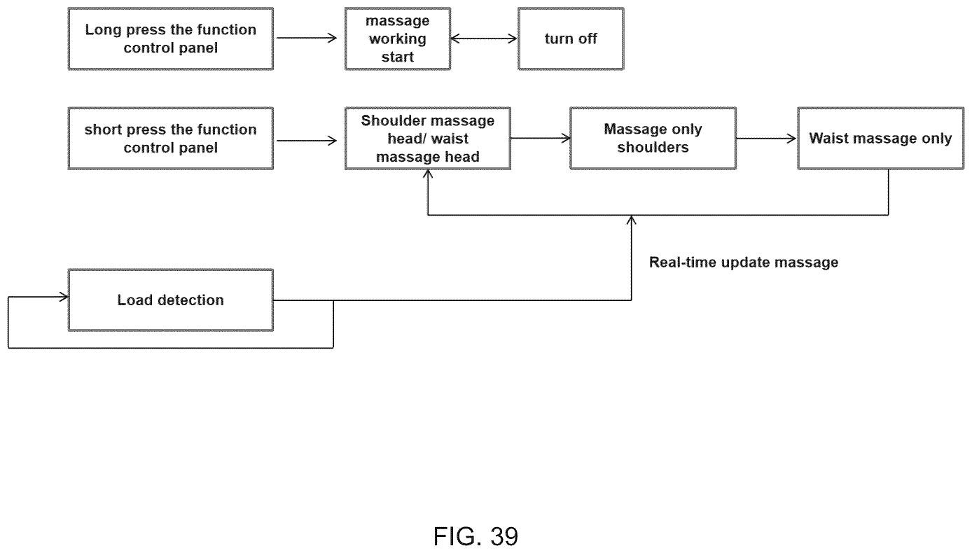

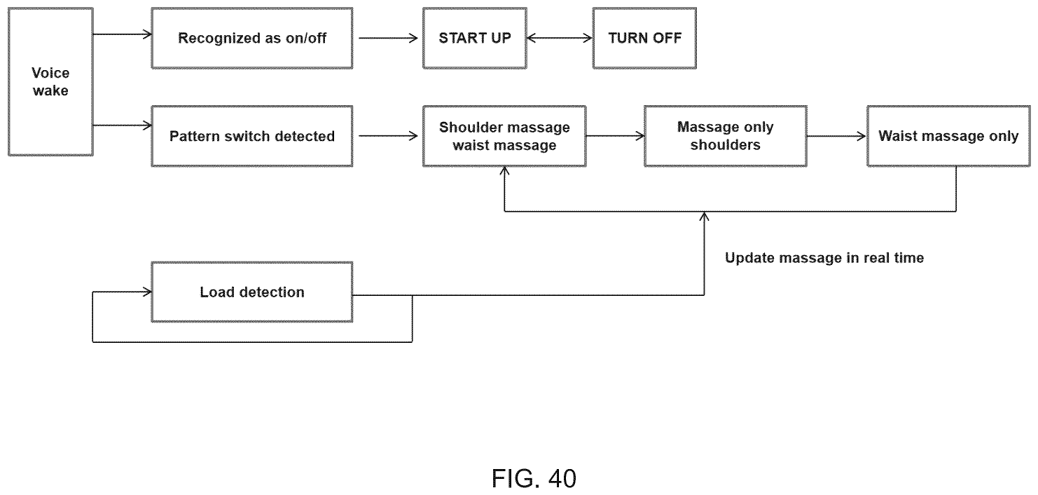

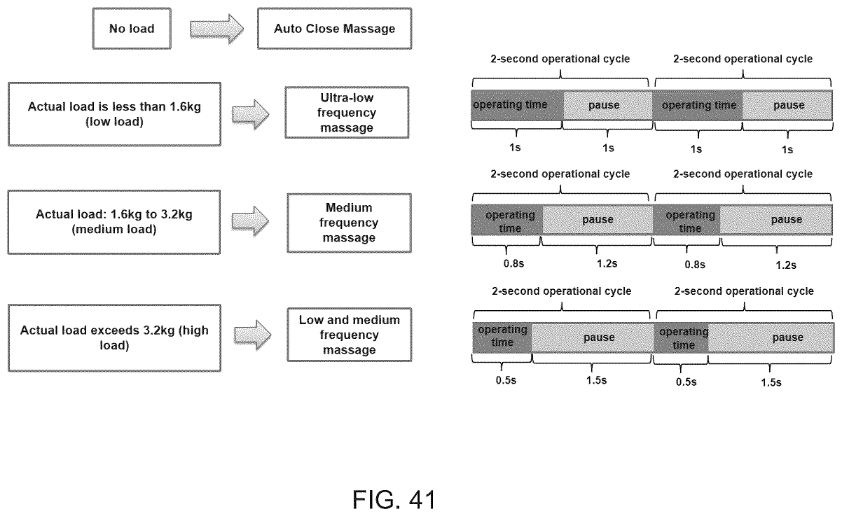

FIGS. 32A-41 show other embodiments of the backpack B shown in FIGS. 1-31C, except as described herein (reference characters are not repeated in the drawings for conciseness and brevity). FIG. 32A is another embodiment of the backpack B shown in FIG. 27B. FIG. 32A shows the backpack B as having one or more detachable accessories D to connect the removable massage system RMS to the wearable body of the backpack B a complete single unit. The removable massage system RMS can be installed on, and detachable from, as a single, complete unit, thereby allowing it to be affixed only when massage functionality is required to enhance physical contact and improve conformity between the massage system and the user's torso. The detachable accessory D is selected from the group consisting of: Velcro, a zipper, a band, tape, snaps, a button, a strip, and a sticker.

FIG. 32B shows an embodiment of the control system CS including the MCU M and a crystal oscillator CO. The crystal oscillator CO is configured to provide a stable clock signal to the MCU M. The control system CS also includes a voice integrated circuit VIC. The MCU is further configured to decode signals from the voice integrated circuit VIC. The control system CS has a multi-mode selection function, selectable from the group consisting of switch button control, voice wake-up, mobile device control, and a no-load automatic shut-off function.

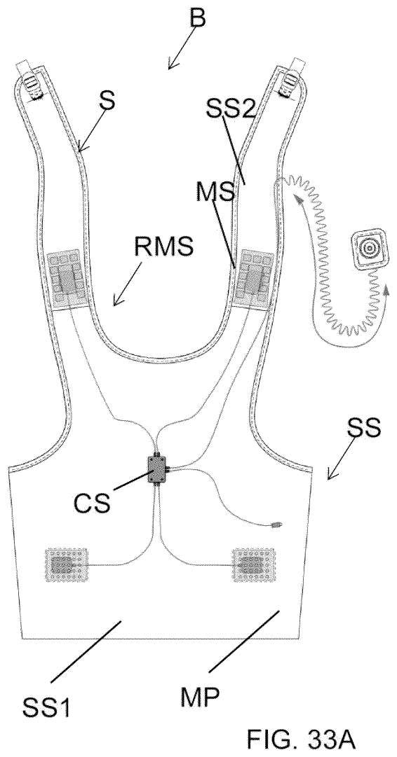

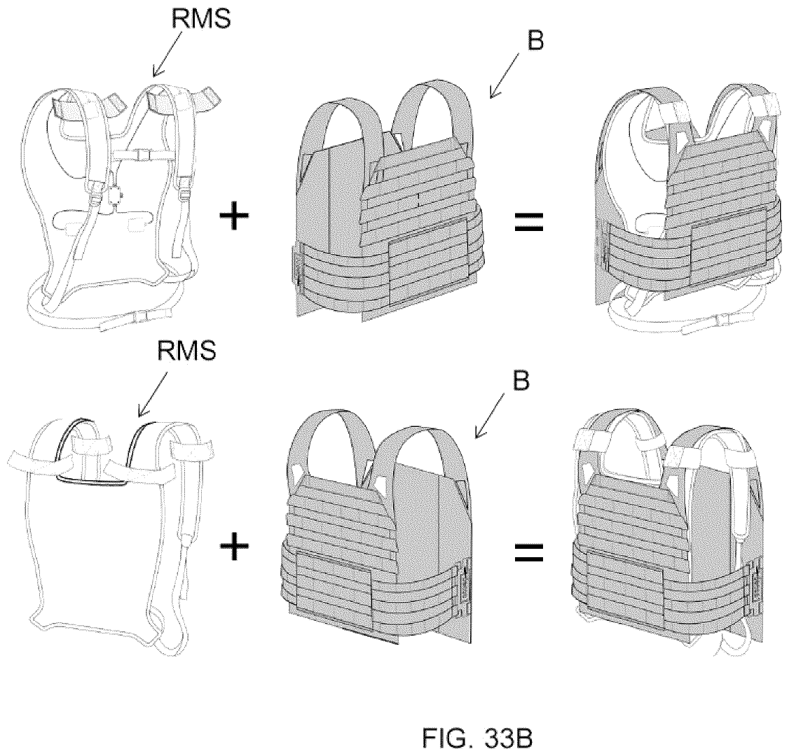

FIG. 33A shows another of the backpack B. The removable massage system RMS includes at least one storage space SS configured to house components of the massage system (e.g., the control system CS, the massage heads H, the MCU M, the wires M, and so forth). The at least one storage space SS is separated into a first part SS1 for housing the control system CS and configured for attachment to the main body portion MP of the wearable body, and a second part SS2 for housing the at least one massage head H and configured for attachment to a shoulder position S of the wearable body B.

FIG. 33B shows an assembly view of the backpack B, showing how the removable massage system RMS fits within the wearable body of the backpack B.

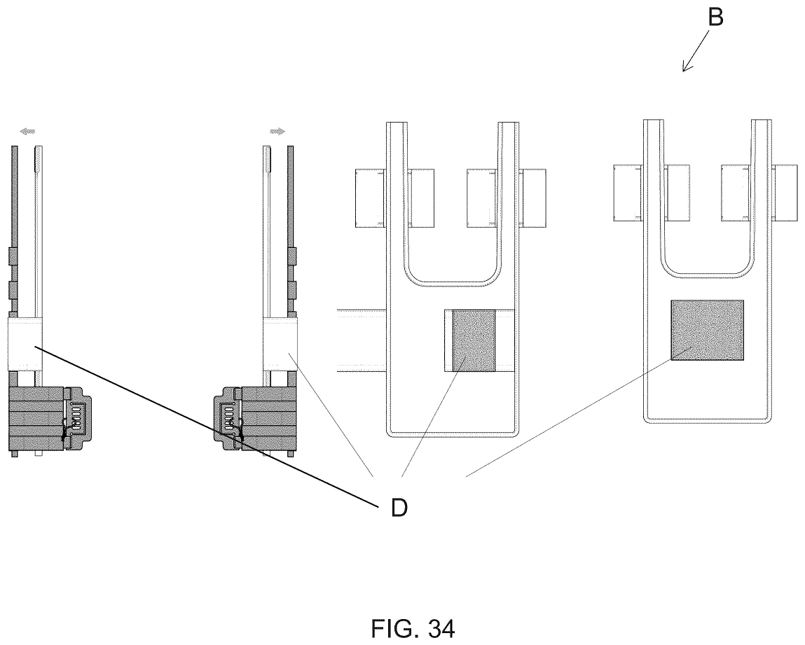

FIG. 34 shows another view of the backpack B with the detachable accessories D.

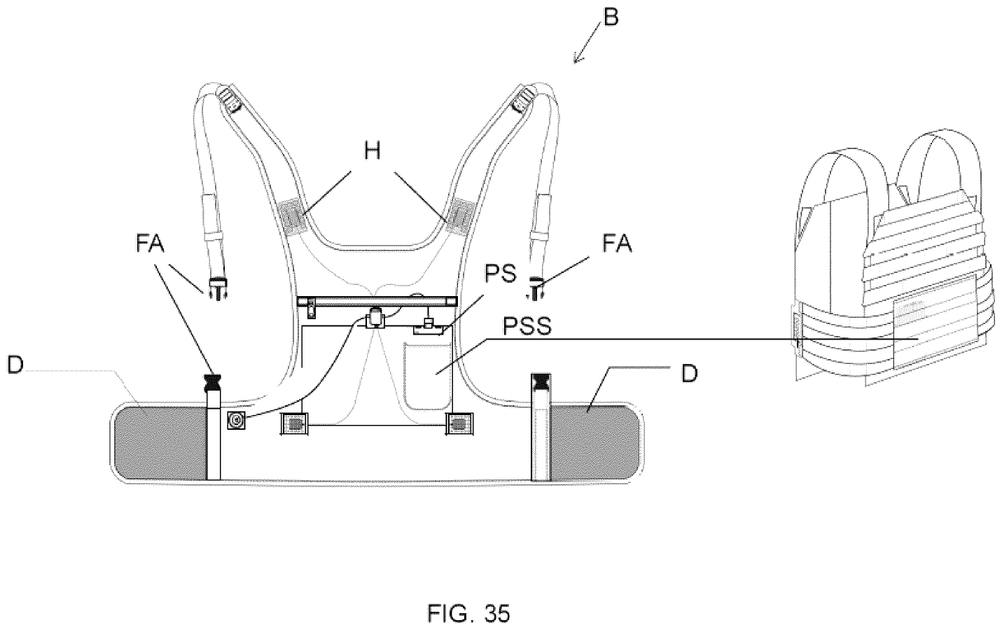

FIG. 35 shows another view of the backpack B. The backpack B is provided with at least one pair of adjustable fastening accessories FA, configured to be tightened or loosened to adjust a fitting tightness of the backpack B against the user's torso. The at least one massage head H is structurally integrated with the backpack B via the detachable accessories D to form a force-coupling interface, enabling transmission of mechanical forces between the wearable body, the user's torso, and the massage head H. A combined effect of the adjustable fastening accessories FA securing the backpack B to the user and the detachable accessories D integrating the massage head H with the backpack B concurrently enhances physical contact of the massage head H against the user's torso, thereby improving massage efficacy and comfort when the massage function is activated. A power supply PS is disposed in a power storage space PSS on the backpack B.

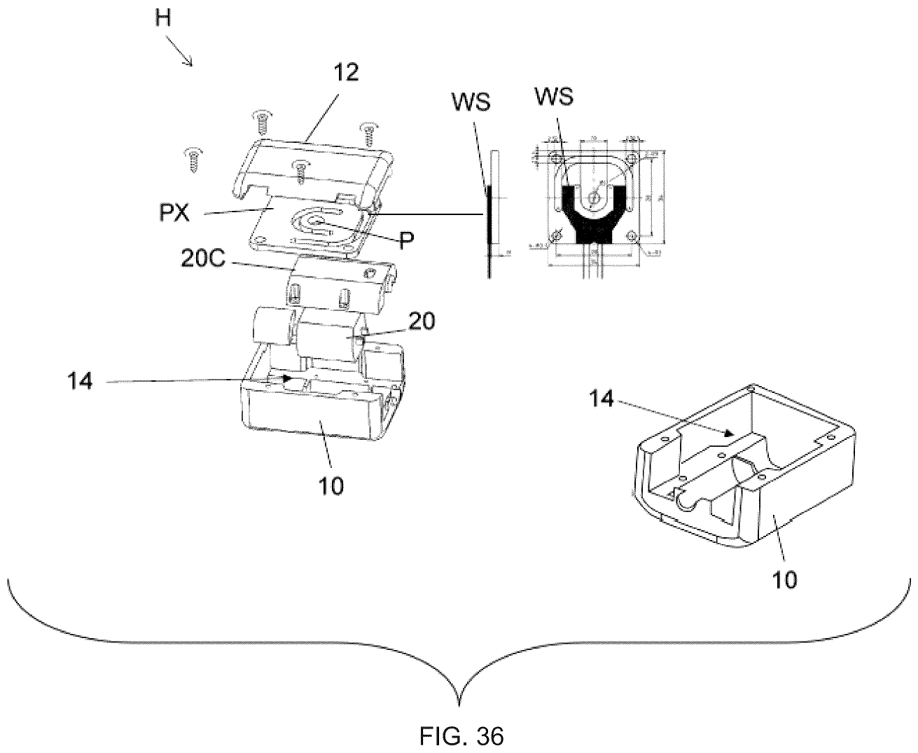

FIG. 36 shows another view of a massage head H. The massage head H comprises the massage actuator 20 and the pressure sensor PX configured to detect, in real-time, pressure variations originating from the load and the user's torso from the backpack B, and to transmit corresponding pressure signals to the MCU. An exterior of the massage head H has a length not exceeding 45 mm and a width not exceeding 35 mm, and is in a shape of a rectangular or oval cylinder. A surface of the massage head H is made of plastic material and comprises the top shell 12, the pressure sensor PX, the massage actuator cover 20C, and the base shell 10, all assembled together via screws or glue to form the massage head H. The massage head H includes a miniature weighing sensor WS connected to the pressure sensor PX that adapts massage frequency based on detected pressure weight, thereby providing a personalized massage experience. The base shell 10 is hollowed out and directly fits to the massage actuator 20. The massage actuator 20 is a crystal-based piezoelectric device configured to generate mechanical vibrations for massage upon application of an electrical signal.

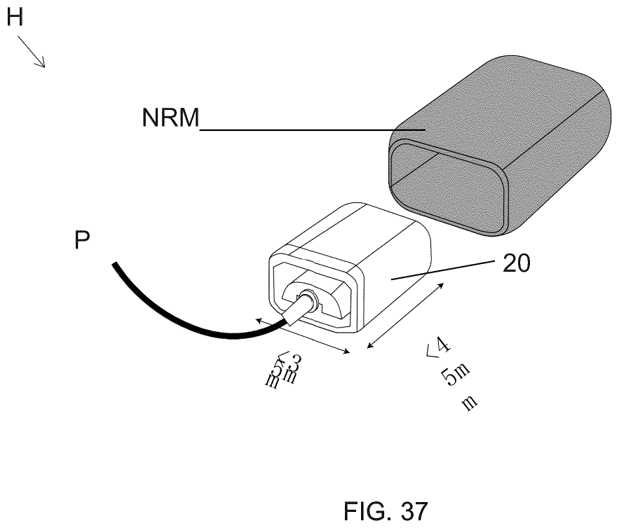

FIG. 37 shows another view of the massage head H. The massage head H has a line port P located between a top part and a bottom part of the massage actuator 20, and the line port P is connected to the power supply PS to complete a power supply operation. A surface of the massage actuator 20 is covered by a noise reduction material NRM to reduce massage noise.

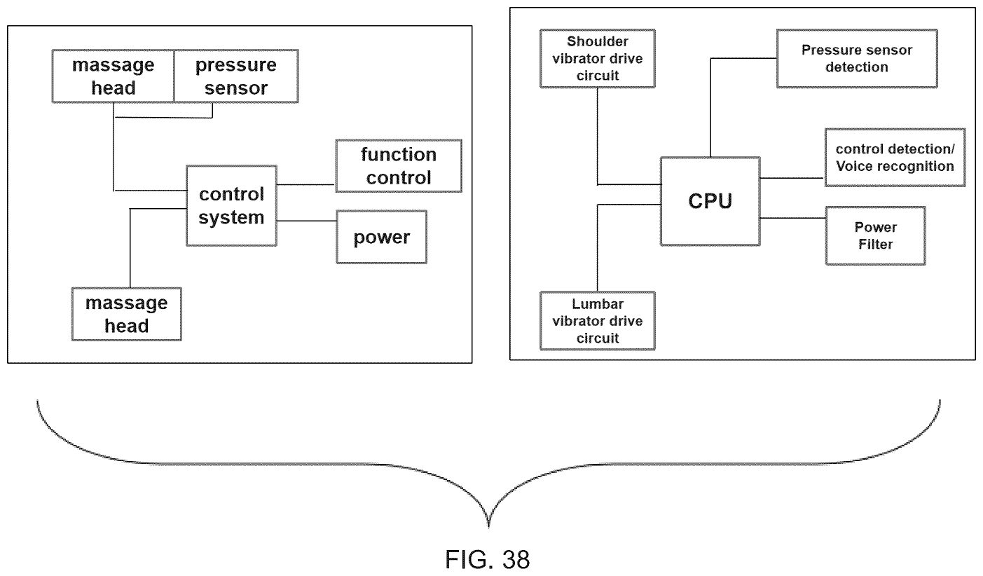

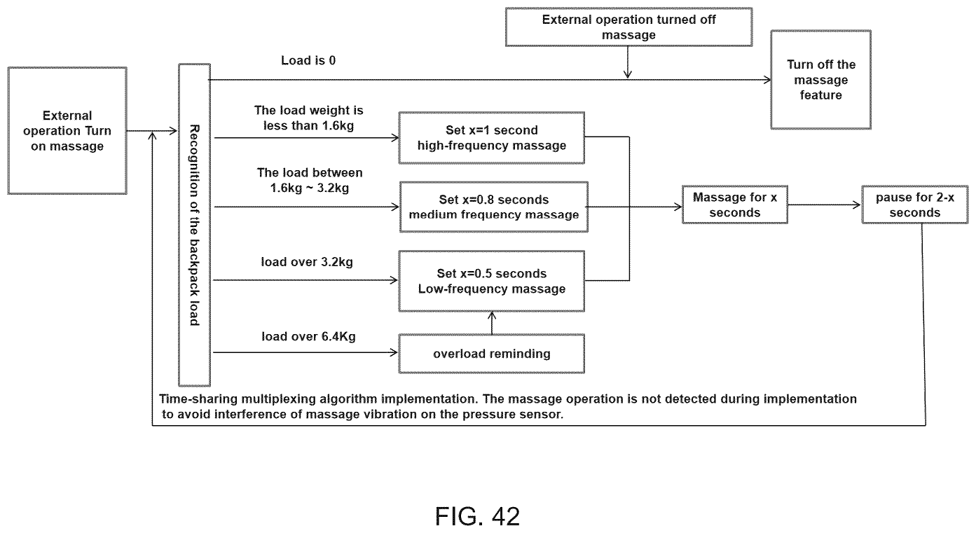

FIGS. 38-42 show different schematics and operation of the backpack B and the removable massage system RMS. The MCU is programmed to: receive and analyze the signals from the pressure sensor PX to determine a required adjustment to massage intensity; and automatically generate and send a control command to the massage actuator 20 to adjust its operation, thereby providing a massage mode tailored to the detected pressure distribution. The MCU is further programmed to select an operational massage mode for the massage actuator 20 based on the detected pressure, such that: a) a first massage mode is selected when the detected pressure corresponds to a load of less than 1.6 kg; b) a second massage mode, distinct from the first massage mode, is selected when the detected pressure corresponds to a load greater than or equal to 1.6 kg and less than 3.2 kg; and c) a third massage mode, distinct from the first and second massage modes, is selected when the detected pressure corresponds to a load greater than or equal to 3.2 kg. The first massage mode comprises a high-frequency micro-vibration operating at a duty cycle configured to be between 40% and 60%. The second massage mode comprises a medium-frequency micro-vibration operating at a duty cycle configured to be between 30% and 50%. The third massage mode comprises a low-frequency micro-vibration operating at a duty cycle configured to be between 20% and 40%. The duty cycle for each massage mode is implemented in a 2-second operational cycle.

Although the present invention is illustrated and described using specific implementations and alternatives thereto, it should be understood that various variations and modifications may be implemented as long as they do not depart from the spirit of the present invention. Accordingly, it should be understood that the present invention is not limited in any sense except by the accompanying claims and their equivalents.

The present disclosure, through one or more of its various aspects, embodiments and/or specific features or sub-components, is thus intended to bring out one or more of the advantages as specifically noted below. For purposes of explanation and not limitation, example embodiments disclosing specific details are set forth in order to provide a thorough understanding of an embodiment according to the present teachings. However, other embodiments consistent with the present disclosure that depart from specific details disclosed herein remain within the scope of the appended claims. Moreover, descriptions of well-known apparatuses and methods may be omitted so as not to obscure the description of the example embodiments. Such methods and apparatuses are within the scope of the present disclosure.

1. A biomechanically adaptive wearable system, comprising:
a wearable body configured to be worn on a user's torso and to bear a load, thereby applying pressure to the user's torso;
a removable massage system detachably integrated with the wearable body; wherein the removable massage system includes at least one storage space configured to house components of the massage system;
wherein the components of the removable massage system comprise a control system, at least one massage head, and a function control panel, interconnected by at least two cables; wherein the removable massage system is provided with at least one pair of a detachable accessory, enabling the entire removable massage system to be detached from the wearable body as a single, complete unit;
wherein the at least one massage head is structurally integrated with the wearable body via the detachable accessories to form a force-coupling interface, enabling transmission of mechanical forces between the wearable body, the user's torso, and the massage head;
wherein the control system comprises a microcontroller unit (MCU) and a crystal oscillator, the crystal oscillator being configured to provide a stable clock signal to the MCU;
wherein the massage head comprises a massage actuator and a pressure sensor configured to detect, in real-time, pressure variations originating from the load and the user's torso, and to transmit corresponding signals to the MCU; and
wherein the MCU is programmed to: receive and analyze the signals from the pressure sensor to determine a required adjustment to massage intensity; and automatically generate and send a control command to the massage actuator to adjust its operation, thereby providing a massage mode tailored to the detected pressure distribution.

2. The biomechanically adaptive wearable system as in claim 1, wherein the detachable accessory is selected from the group consisting of: Velcro, a zipper, a band, tape, snaps, a button, a strip, and a sticker.

3. The biomechanically adaptive wearable system as in claim 1, wherein the at least one storage space is separated into a first part for housing the control system and configured for attachment to a main body portion of the wearable body, and a second part for housing the at least one massage head and configured for attachment to a shoulder position of the wearable body.

4. The biomechanically adaptive wearable system as in claim 1, further comprising a power supply disposed in a power storage space on the wearable body.

5. The biomechanically adaptive wearable system as in claim 1, wherein the function control panel comprises a voice integrated circuit (IC).

6. The biomechanically adaptive wearable system as in claim 5, wherein the MCU is further configured to decode signals from the voice IC.

7. The biomechanically adaptive wearable system as in claim 1, wherein the function control panel has a multi-mode selection function, selectable from the group consisting of: switch button control, voice wake-up, mobile device control, and a no-load automatic shut-off function.

8. The biomechanically adaptive wearable system as in claim 1, wherein the massage head has an exterior part with a length not exceeding 45 mm and a width not exceeding 35 mm, and is in a shape of a rectangular or oval cylinder.

9. The biomechanically adaptive wearable system as in claim 1, wherein a surface of the massage head is made of plastic material and comprises a top shell, the pressure sensor, a massage actuator cover, and a base shell, all assembled together via screws or glue to form the massage head.

10. The biomechanically adaptive wearable system as in claim 1, wherein the massage head is configured with a miniature weighing sensor that adapts massage frequency based on detected pressure weight, thereby providing a personalized massage experience.

11. The biomechanically adaptive wearable system as in claim 1, wherein the massage system has a line port located between an upper cover and a lower cover of an oscillator, and the line port is connected to a power supply to complete a power supply operation.

12. The biomechanically adaptive wearable system as in claim 1, wherein the base shell of the massage head is hollowed out and directly fits to the massage actuator.

13. The biomechanically adaptive wearable system as in claim 1, wherein a surface of the massage actuator is covered by a noise reduction material to reduce massage noise.

14. The biomechanically adaptive wearable system as in claim 1, wherein the massage actuator is a crystal-based piezoelectric device configured to generate mechanical vibrations for massage upon application of an electrical signal.

15. The biomechanically adaptive wearable system as in claim 2, wherein the MCU is further programmed to select an operational massage mode for the massage actuator based on the detected pressure, such that:
a) a first massage mode is selected when the detected pressure corresponds to a load of less than 1.6 kg;
b) a second massage mode, distinct from the first massage mode, is selected when the detected pressure corresponds to a load greater than or equal to 1.6 kg and less than 3.2 kg;
c) a third massage mode, distinct from the first and second massage modes, is selected when the detected pressure corresponds to a load greater than or equal to 3.2 kg.

16. The biomechanically adaptive wearable system as in claim 15, wherein:
the first massage mode comprises a high-frequency micro-vibration operating at a duty cycle configured to be between 40% and 60%;
the second massage mode comprises a medium-frequency micro-vibration operating at a duty cycle configured to be between 30% and 50%;
the third massage mode comprises a low-frequency micro-vibration operating at a duty cycle configured to be between 20% and 40%.

17. The biomechanically adaptive wearable system as in claim 16, wherein the duty cycle for each massage mode is implemented in a 2-second operational cycle.

18. The biomechanically adaptive wearable system as in claim 1, wherein the wearable body is a vest or a backpack.

19. A biomechanically adaptive wearable system, comprising:
a wearable body configured to be worn on a user's torso and to bear a load, thereby applying pressure to the user's torso;
a removable massage system detachably integrated with the wearable body; wherein the removable massage system includes at least one storage space configured to house components of the massage system;
wherein the components of the removable massage system comprise a control system, at least one massage head, and a function control panel, interconnected by at least two cables;
wherein the removable massage system is provided with at least one pair of detachable accessories, enabling the entire removable massage system to be installed on and detached from the wearable body as a single, complete unit, thereby allowing it to be affixed only when massage functionality is required to enhance physical contact and improve conformity between the massage system and the user's torso;
wherein the wearable body is provided with at least one pair of adjustable fastening accessories, configured to be tightened or loosened to adjust a fitting tightness of the wearable body against the user's torso;
wherein the at least one massage head is structurally integrated with the wearable body via the detachable accessories to form a force-coupling interface, enabling transmission of mechanical forces between the wearable body, the user's torso, and the massage head; and
wherein a combined effect of the adjustable fastening accessories securing the wearable body to the user and the detachable accessories integrating the massage head with the wearable body concurrently enhances physical contact of the massage head against the user's torso, thereby improving massage efficacy and comfort when the massage function is activated.

20. A biomechanically adaptive wearable system, comprising:
a wearable body configured to be worn on a user's torso and to bear a load;
a removable massage system detachably integrated with the wearable body; the removable massage system including at least:
at least one massage head structurally integrated with the wearable body via at least one pair of a detachable accessory, the at least one massage head comprising:
a massage actuator; and
a pressure sensor configured to detect, in real-time, pressure variations originating from the load and the user's torso; and
a control system including a microcontroller unit programmed to:
receive and analyze the signals from the pressure sensor to determine a required adjustment to massage intensity; and
automatically generate and send a control command to the massage actuator to operate according to the determined required adjustment.
